(19) United States
(12) Patent Application Publication
(10) Pub. No.: US 2024/0005791 A1
(43) Pub. Date: Jan. 4, 2024

(54) DRIVING ASSISTANCE SYSTEM, SERVER DEVICE, AND DRIVING ASSISTANCE INFORMATION GENERATION METHOD

(71) Applicant: MITSUBISHI ELECTRIC CORPORATION, Tokyo (JP)

(72) Inventors: Mari OCHIAI, Tokyo (JP); Shusaku UMEDA, Tokyo (JP); Takeshi SUEHIRO, Tokyo (JP); Teruko FUJII, Tokyo (JP); Takashi ASAHARA, Tokyo (JP); Masaaki TAKEYASU, Tokyo (JP)

(73) Assignee: MITSUBISHI ELECTRIC CORPORATION, Tokyo (JP)

(21) Appl. No.: 18/369,970

(22) Filed: Sep. 19, 2023

Related U.S. Application Data
(63) Continuation of application No. PCT/JP2021/014814, filed on Apr. 7, 2021.

(51) Int. Cl. G08G 1/0967; G08G 1/01; H04W 4/44

(52) U.S. Cl. CPC G08G 1/096783; G08G 1/0116; G08G 1/0125; H04W 4/44

(57) ABSTRACT

A driving assistance system includes a roadside server connected to a roadside sensor and a roadside device. The roadside server includes a sensor information processing unit, an assistance information generation unit, and a roadside device interface. Using information indicating a state in the detection range of the roadside sensor from the roadside sensor, the sensor information processing unit generates sensing information of a first dynamic object within the detection range. The assistance information generation unit generates driving assistance information by combining surrounding object information and the sensing information. The roadside device interface transmits the driving assistance information to the roadside device.

### CROSS-REFERENCE TO RELATED APPLICATION

This application is a continuation application of International Application PCT/JP2021/014814, filed on Apr. 7, 2021, and designating the U.S., the entire contents of which are incorporated herein by reference.

### BACKGROUND OF THE INVENTION

### 1. Field of the Invention

The present disclosure relates to a driving assistance system, a server device, and a driving assistance information generation method, which are intended to provide driving assistance information that is information for assisting drive to a vehicle present in a communication range of a roadside device.

### 2. Description of the Related Art

Systems such as Driving Safety Support Systems (DSSS) and ITS Connect, which provide a vehicle with sensor information from cameras or the like installed on roads using road-to-vehicle communication have been in operation at intersections and the like with poor visibility.

In such services, sensors are provided on locations where visibility from vehicles is poor, and information on areas that are difficult to see from vehicles is provided from a roadside device to a vehicle using narrow-area communication. These services are advantageous in that information of a roadside sensor can be sent from the roadside device with low delay, but are disadvantageous in that information or the like on vehicles approaching from outside the detection range of the roadside sensor is not provided. It is not realistic to cover all directions at an intersection or the like with roadside sensors; and as it now stands, roadside sensors are installed only in places with the poorest visibility. There may however be cases where smoother passage can be achieved if information regarding movement of vehicles, people, and the like near an intersection is provided in addition to information of roadside sensors.

Japanese Patent Application Laid-open No. 2019-185366 discloses a device that collects sensor data from a plurality of roadside sensors using wide-area communication, generates driving assistance information in consideration of a delay time required for collection of each set of sensor data, and delivers the driving assistance information.

However, the technique described in Japanese Patent Application Laid-open No. 2019-185366 has been problematic in that the generated driving assistance information is information obtained from the roadside sensors, and information on a vehicle approaching from outside the detection range of the roadside sensors is not included in the driving assistance information.

### SUMMARY OF THE INVENTION

In order to solve the above-described problems, the present disclosure provides a driving assistance system comprising a roadside server connected to a roadside sensor and a roadside device, the roadside server acquiring information from the roadside sensor and transmitting driving assistance information to the roadside device, wherein the roadside server comprises: a sensor information processing circuit to generate sensing information using information indicating a state in a detection range of the roadside sensor from the roadside sensor, the sensing information including a position and a movement direction of a first dynamic object within the detection range; an assistance information generation circuit to generate driving assistance information by combining surrounding object information and the sensing information, the surrounding object information being obtained by extracting predicted position information present within an information provision range including the detection range and being wider than the detection range, the predicted position information including a predicted position of a second dynamic object predicted from probe information in consideration of delays in wide-area communication that uses radio communication involving a base station and in processing in the roadside server, the probe information including a position and a velocity of the second dynamic object within a predetermined range and being allowed to be delayed, the driving assistance information including a position and a velocity of a dynamic object in the information provision range; and a roadside device interface to transmit the driving assistance information to the roadside device.

### BRIEF DESCRIPTION OF THE DRAWINGS

FIG. 1 is a diagram schematically illustrating an exemplary configuration of a driving assistance system according to a first embodiment;

FIG. 2 is a block diagram illustrating an exemplary functional configuration of a roadside server according to the first embodiment;

FIG. 3 is a diagram illustrating an example of roadside-device area information;

FIG. 4 is a block diagram illustrating an exemplary functional configuration of a server according to the first embodiment;

FIG. 5 is a diagram illustrating an example of roadside-device delay information;

FIG. 6 is a diagram illustrating an example of roadside-device area information;

FIG. 7 is a flowchart illustrating an exemplary procedure for a driving assistance method in the driving assistance system according to the first embodiment;

FIG. 8 is a diagram illustrating an example of provision of driving assistance information in the driving assistance system according to the first embodiment;

FIG. 9 is a diagram schematically illustrating another exemplary configuration of the driving assistance system according to the first embodiment;

FIG. 10 is a diagram schematically illustrating another exemplary configuration of the driving assistance system according to the first embodiment;

FIG. 11 is a diagram schematically illustrating an exemplary configuration of a driving assistance system according to a second embodiment;

FIG. 12 is a block diagram illustrating an exemplary functional configuration of a roadside server according to the second embodiment;

FIG. 13 is a diagram schematically illustrating another exemplary configuration of the driving assistance system according to the second embodiment;

FIG. 14 is a diagram schematically illustrating an exemplary configuration of a driving assistance system according to a third embodiment;

FIG. 15 is a block diagram illustrating an exemplary functional configuration of a roadside server according to the third embodiment;

FIG. 16 is a diagram schematically illustrating an exemplary configuration of a driving assistance system according to a fourth embodiment;

FIG. 17 is a block diagram illustrating an exemplary functional configuration of a roadside server according to the fourth embodiment;

FIG. 18 is a block diagram illustrating an exemplary functional configuration of a server according to the fourth embodiment;

FIG. 19 is a diagram schematically illustrating an exemplary configuration of a driving assistance system according to a fifth embodiment;

FIG. 20 is a block diagram illustrating an exemplary functional configuration of a roadside server according to the fifth embodiment;

FIG. 21 is a diagram schematically illustrating an exemplary configuration of a driving assistance system according to a sixth embodiment;

FIG. 22 is a block diagram illustrating an exemplary functional configuration of a roadside server according to the sixth embodiment;

FIG. 23 is a block diagram illustrating an exemplary hardware configuration of the roadside server according to any of the first to sixth embodiments; and

FIG. 24 is a block diagram illustrating an exemplary hardware configuration of the server according to any of the first to sixth embodiments.

### DETAILED DESCRIPTION OF THE PREFERRED EMBODIMENTS

Hereinafter, a driving assistance system, a server device, and a driving assistance information generation method according to embodiments of the present disclosure will be described in detail with reference to the drawings.

### First Embodiment

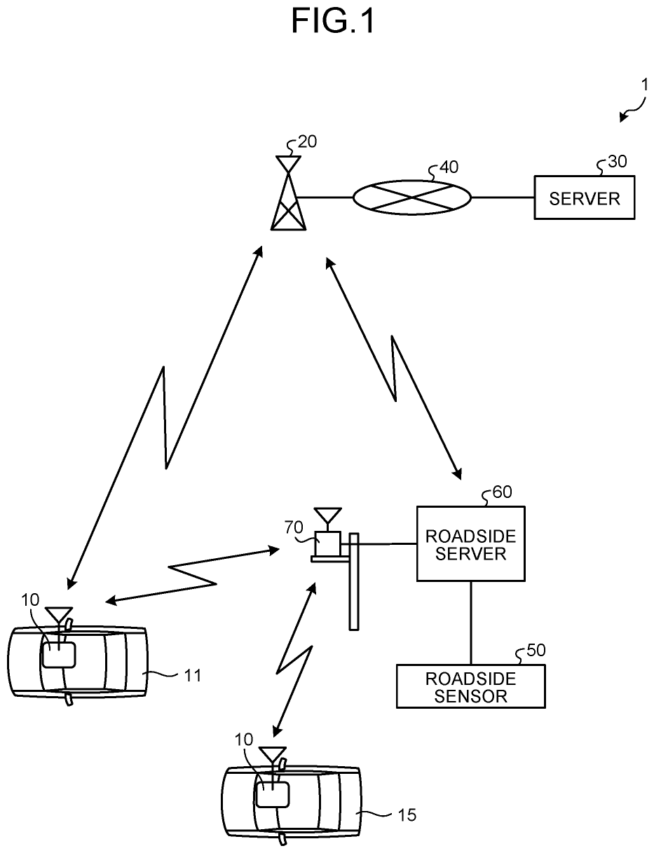

FIG. 1 is a diagram schematically illustrating an exemplary configuration of a driving assistance system according to the first embodiment. The following description provides an example in which dynamic information of a dynamic map is provided as driving assistance information from a roadside device 70. Note that the dynamic map is information in which static map information including lane information, road surface information, and three-dimensional structures is overlapped with dynamic information including the positions of dynamic objects such as pedestrians, bicycles, and vehicles 11 and 15 that change with time. Hereinafter, the vehicles 11 and 15 mean some conveyances such as automobiles and motorcycles which can travel by rotating wheels by means of an internal combustion engine or electric motor. In the following example, driving assistance information including information on the vehicle 11 is provided to the vehicle 15.

The driving assistance system 1 includes an in-vehicle device 10, a base station 20, a server 30, a roadside sensor 50, a roadside server 60, and the roadside device 70.

The in-vehicle device 10 is a communication device that is installed in each of the vehicles 11 and 15 and has interfaces for both wide-area communication and narrow-area communication. The in-vehicle device 10 periodically or regularly transmits probe information including the position and velocity of the corresponding vehicle 11 or 15 using wide-area communication, and receives driving assistance information using narrow-area communication in the communication range of the roadside device 70. The probe information transmitted from the in-vehicle device 10 is collected in the server 30 via the base station 20 and a core network 40 in wide-area communication. Note that the first embodiment is based on the assumption that wide-area communication is provided by one telecommunications carrier that provides mobile phone service. For ease of explanation, the following example is given for a case where the in-vehicle device 10 of the vehicle 11 transmits probe information and the in-vehicle device 10 of the vehicle 15 receives the driving assistance information. On the other hand, the in-vehicle device 10 of the vehicle 15 also transmits probe information, and the in-vehicle device 10 of the vehicle 11 may receive the driving assistance information depending on the circumstances.

The base station 20 performs radio communication with the in-vehicle device 10, the roadside server 60, and the like using wide-area communication. In one example, the base station 20 is a wireless base station for mobile phones.

The server 30 processes the probe information of the vehicle 11 collected via the base station 20 in wide-area communication, and generates surrounding object information to be provided to the roadside server 60. The surrounding object information is prediction information of a vehicle state including the velocity and position of the vehicle 11. Here, the velocity includes a speed and a direction. The surrounding object information includes position information on the vehicle 11 predicted to be present in an information provision range that is a range including the detection range of the roadside sensor 50 and being wider than the detection range. The information provision range is a geographical range in which the vehicle 11 included in the information provided by the server 30 to the roadside server 60 connected to the roadside device 70 is present. In this example, there is provided a case where an object to be managed by the server 30 is the vehicle 11, but the object to be managed is not limited to only the vehicle 11, and any object may be adopted as long as it has a communication device, such as a pedestrian or a bicycle. In this case, the server 30 additionally collects probe information through wide-area communication from a communication device possessed by a pedestrian, a bicycle, or the like. However, for simplicity, the following embodiments give description of examples in which the object to be managed is the vehicle 11. The base station 20 and the server 30 are connected by the core network 40 in wide-area communication.

An information collection range that is a range in which the probe information of the vehicle 11 is collected by means of wide-area communication is set with being intended for the entire range assumed in the driving assistance system 1. For example, in the driving assistance system 1 that only provides driving assistance information from the roadside device 70, the information collection range can be a range that includes the information provision range and is set in consideration of the time required for the processing in which the server 30 collects probe information from the in-vehicle device 10 and the roadside server 60 receives the surrounding object information generated by the server 30, or in other words, a range in which the vehicle 11 reaches the information provision range during the time required for the processing. Alternatively, in the presence of a plurality of roadside devices 70 that provide information, the information collection range is a range that can cover the vehicles 11 predicted to be present in the information provision ranges of all the roadside devices 70.

The roadside sensor 50 detects a state in the detection range that is a range in which the roadside sensor 50 performs its detection, and transmits detection result information that is a result of the detection, to the roadside server 60. An example of a state in the detection range is motion of the vehicle 11 or the like in the detection range. The vehicle 11 or the like detected by the roadside sensor 50 corresponds to a first dynamic object.

The roadside server 60 has an interface for wide-area communication, and receives surrounding object information from the server 30 through wide-area communication. The roadside server 60 is connected to the roadside sensor 50 by wire, and generates real-time sensing information about the surroundings from the detection result information of the roadside sensor 50. In one example, the sensing information is information indicating the position and movement direction of a dynamic object in the detection range of the roadside sensor 50. Further, the roadside server 60 combines the sensing information and the surrounding object information received from the server 30 through wide-area communication to generate driving assistance information to be provided to the vehicle 15 traveling in a roadside-device communication range. The driving assistance information generated by the roadside server 60 is transmitted from the roadside device 70 to the vehicle 15 in the roadside-device communication range. The roadside server 60 corresponds to a server device.

The roadside device 70 provides information to the in-vehicle device 10 of the vehicle 15 using narrow-area communication. In this example, driving assistance information including information about the vehicle 11 generated by the roadside server 60 is transmitted to the in-vehicle device 10 of the vehicle 15 in the roadside-device communication range.

Here, wide-area communication is, for example, radio communication using mobile phone lines in a fifth-generation mobile communication system or the like. Generally, wide-area communication is radio communication involving the base station 20. Narrow-area communication is radio communication for the vehicles 11 and 15, such as Dedicated Short Range Communication (DSRC). An example of narrow-area communication is communication using PC5 interface or the like in Electronic Toll Collection System (ETC) 2.0, Institute of Electrical and Electronics Engineers (IEEE) 802.11p, or Third Generation Partnership Project (3GPP). Note that a fifth-generation mobile communication system is hereinafter referred to as 5th Generation (5G).

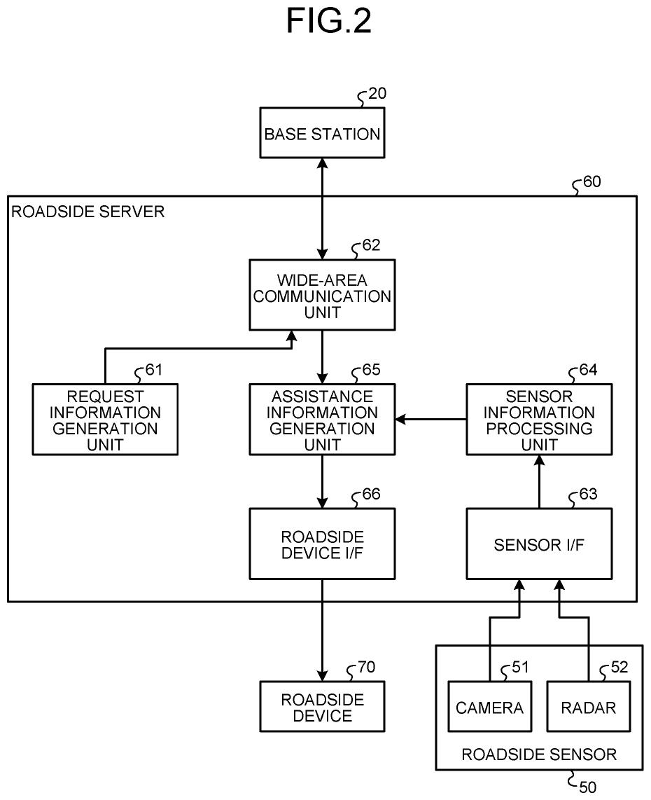

FIG. 2 is a block diagram illustrating an exemplary functional configuration of the roadside server according to the first embodiment. The roadside server 60 includes a request information generation unit or circuit 61, a wide-area communication unit or circuit 62, a sensor interface (I/F) 63, a sensor information processing unit or circuit 64, an assistance information generation unit or circuit 65, and a roadside device I/F 66.

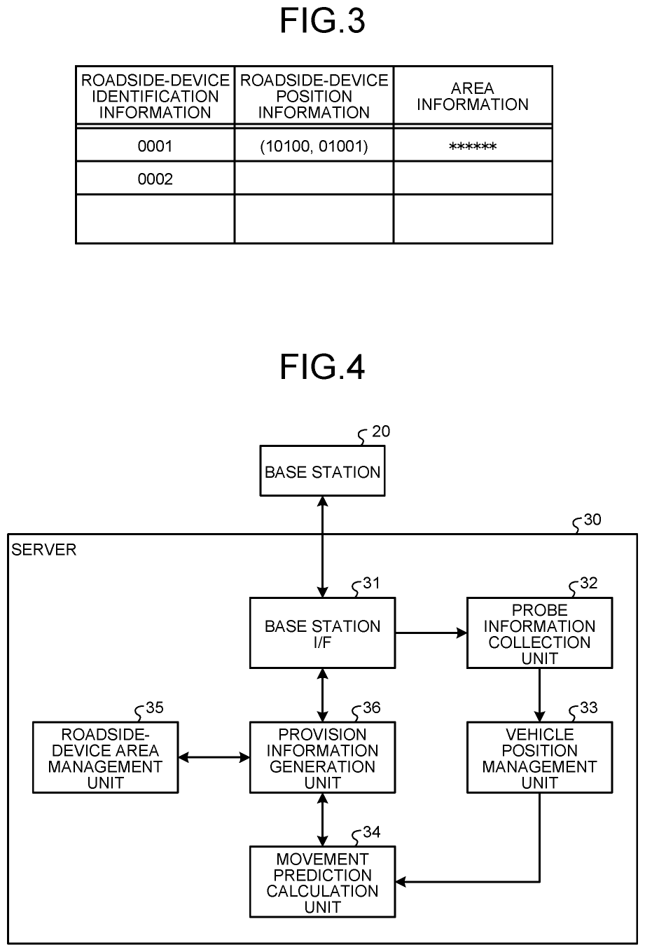

The request information generation unit 61 generates request information including information designating an area of vehicle position information indicating the position of the vehicle 11 required by the roadside server 60. The area of vehicle position information required by the roadside server 60 corresponds to the information provision range of the roadside device 70. In this description part, an example is given in which the driving assistance system 1 has a plurality of information provision ranges. In this case, the server 30 and the roadside server 60 share roadside-device area information that is information in which roadside-device identification information that is information for identifying the roadside device 70 and an information provision range are linked with each other. FIG. 3 is a diagram illustrating an example of roadside-device area information. The roadside-device area information is information in which roadside-device identification information for identifying the roadside device 70, roadside-device position information indicating the geographical position of the roadside device 70, and area information indicating an information provision range are linked with each other. In one example, the roadside-device position information is information indicating a position on a map shared by the server 30 and the roadside server 60. In one example, the request information includes the roadside-device identification information or roadside-device position information in FIG. 3 from which area information can be determined. Note that what is illustrated here is just an example, and information designating an area of vehicle position information may be any information from which the server 30 can determine the information provision range required by each roadside server 60. In addition, if the driving assistance system 1 has only one information provision range, request information is not essential.

Returning to FIG. 2, the wide-area communication unit 62 communicates with the server 30 via the base station 20 by means of wide-area communication. In one example, the wide-area communication unit 62 transmits the request information generated by the request information generation unit 61 to the server 30. In addition, the wide-area communication unit 62 receives surrounding object information from the server 30.

The sensor I/F 63 is connected to the roadside sensor 50, acquires the detection result information detected by the roadside sensor 50, and outputs the acquired detection result information to the sensor information processing unit 64 in real time. Examples of the roadside sensor 50 include a camera 51 and a radar 52. In FIG. 2, the roadside sensors 50 has two sensors, that is, the camera 51 and the radar 52, but only needs to have one or more sensors. Besides the camera 51 and the radar 52, another sensor such as light detection and ranging (LiDAR) may be used, or a plurality of sensors of the same type may be provided therefor.

The sensor information processing unit 64 generates sensing information in the detection range near the roadside sensor 50 using the detection result information detected by the roadside sensor 50. The sensor information processing unit 64 outputs the sensing information to the assistance information generation unit 65.

The assistance information generation unit 65 generates driving assistance information by combining the surrounding object information in the information provision range corresponding to the position of the roadside device 70 acquired from the server 30 via the wide-area communication unit 62 and the sensing information in the detection range of the roadside sensor 50 generated by the sensor information processing unit 64. In this manner, the roadside server 60 generates the driving assistance information including information on dynamic objects including the vehicle 11 obtained from the roadside sensor 50 in the detection range of the roadside sensor 50, and also including information on dynamic objects including the vehicle 11 in the information provision range wider than the detection range of the roadside sensor 50. The driving assistance information is, for example, dynamic information on the dynamic map, or information including the position and velocity of another vehicle within the information provision range, which can be processed with being superposed on a map held in the vehicle 15.

The roadside device I/F 66 is an interface that communicates with the roadside device 70. Here, the roadside device I/F 66 transmits the driving assistance information from the assistance information generation unit 65 to the roadside device 70. The roadside device 70 transmits the driving assistance information toward the roadside-device communication range by means of narrow-area communication. When the vehicle 15 is present in the roadside-device communication range, the driving assistance information is received by the in-vehicle device 10, and the dynamic assistance information is displayed with being superposed on the static map information on a display provided in the vehicle 15.

FIG. 4 is a block diagram illustrating an exemplary functional configuration of the server according to the first embodiment. The server 30 includes a base station I/F 31, a probe information collection unit or circuit 32, a vehicle position management unit or circuit 33, a movement prediction calculation unit or circuit 34, a roadside-device area management unit or circuit 35, and a provision information generation unit or circuit 36.

The base station I/F 31 is an interface that performs communication with the base station 20. In one example, the base station I/F 31 receives request information from the roadside server 60, receives probe information from the in-vehicle device 10, and transmits surrounding object information to the roadside server 60. Connection is made between the server 30 and the in-vehicle device 10 or the roadside server 60 by the base station I/F 31.

The probe information collection unit 32 collects probe information from the vehicle 11 in the information collection range that is a predetermined range. The vehicle 11 from which probe information is to be collected corresponds to a second dynamic object. From the probe information, the vehicle position management unit 33 manages information such as a position or velocity of the vehicle 11 within the information collection range.

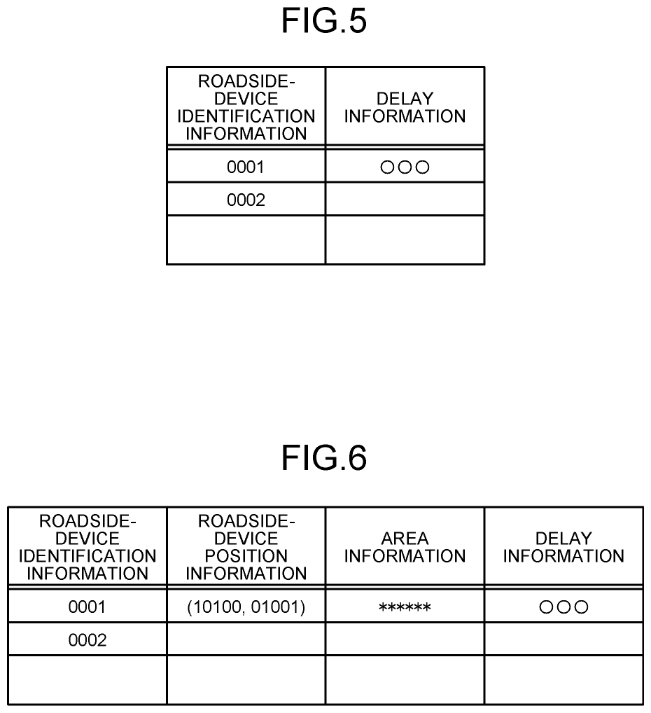

The movement prediction calculation unit 34 calculates predicted position information that is information on the predicted movement of each vehicle 11 managed by the vehicle position management unit 33. The predicted position information includes the predicted position of the vehicle 11. In one example, the movement prediction calculation unit 34 calculates predicted position information in consideration of the delay time taken to pass the surrounding object information to the roadside server 60. Because wide-area communication has a longer delay time than narrow-area communication, calculation of the predicted position information in consideration of the delay time is performed for information received through wide-area communication. The delay time is determined in consideration of delays in wide-area communication that uses radio communication involving the base station 20 and in processing in the roadside server 60. The movement prediction calculation unit 34 acquires the delay time by reference to roadside-device delay information that is information in which an information provision range, that is, the roadside device 70, is linked with a delay time. FIG. 5 is a diagram illustrating an example of roadside-device delay information. The roadside-device delay information is information in which roadside-device identification information is linked with delay information indicating a delay time set for each roadside device 70.

As illustrated in FIG. 5, delay information is linked with roadside-device identification information. Therefore, in the case where the server 30 and the roadside server 60 share roadside-device area information in which roadside-device identification information and an information provision range are linked with each other, the roadside-device area information held by the server 30 may further include delay information. FIG. 6 is a diagram illustrating an example of roadside-device area information. The roadside-device area information in FIG. 6 is information obtained by adding an item of delay information to the roadside-device area information in FIG. 3. Delay information refers to a delay time used in calculating the predicted position of the vehicle 11.

Returning to FIG. 4, the roadside-device area management unit 35 manages correspondence between the position of each roadside device 70 in the area managed by the server 30 and the information provision range that is the area of vehicle position information to be passed to each roadside server 60. Specifically, by reference to the roadside-device area information, the roadside-device area management unit 35 acquires the information provision range corresponding to the information designating an area of vehicle position information included in the request information from the roadside server 60, and designates the acquired information provision range to the provision information generation unit 36.

The provision information generation unit 36 generates surrounding object information from which the vehicle 11 whose predicted position information is present in the information provision range designated by the roadside-device area management unit 35 has been extracted. The surrounding object information is obtained by extracting the vehicle position information present in the information provision range around the roadside device 70. The provision information generation unit 36 transmits the surrounding object information to the roadside server 60 via the base station I/F 31 and the base station 20.

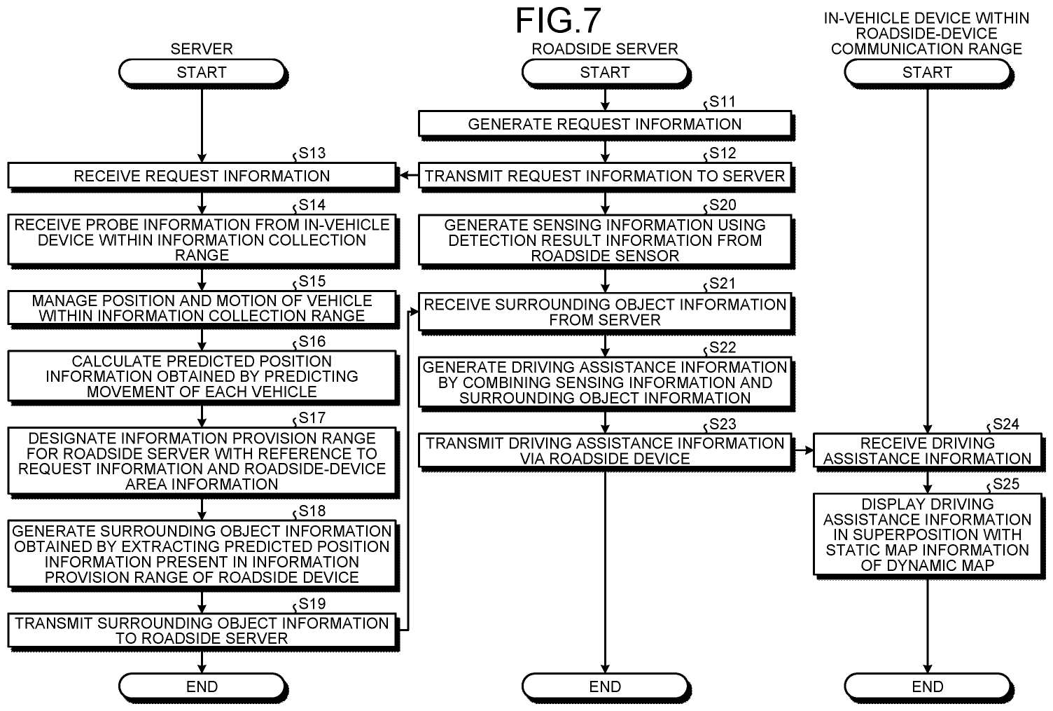

Next, the operation of the driving assistance system 1 according to the first embodiment will be described. FIG. 7 is a flowchart illustrating an exemplary procedure for a driving assistance method in the driving assistance system according to the first embodiment. This figure shows, operations of the server 30, the roadside server 60, and the in-vehicle device 10 of the vehicle 15 within the roadside-device communication range.

First, the request information generation unit 61 of the roadside server 60 generates request information (step S11), and the wide-area communication unit 62 transmits the request information to the server 30 (step S12). In one example, the request information includes the roadside-device identification information of the roadside device 70 connected to the roadside server 60.

The base station I/F 31 of the server 30 receives the request information from the roadside server 60 (step S13). In addition, the probe information collection unit 32 of the server 30 receives probe information from the in-vehicle device 10 within the information collection range via the base station I/F 31 (step S14). In one example, the probe information is information including the position and velocity of the vehicle 11 equipped with the in-vehicle device 10, and is periodically or regularly transmitted by the in-vehicle device 10. The vehicle position management unit 33 of the server 30 manages, based on the received probe information, the position and motion of the vehicle 11 within the information collection range (step S15).

Thereafter, the movement prediction calculation unit 34 calculates predicted position information on the predicted movement of each vehicle 11 (step S16). At this time, the movement prediction calculation unit 34 extracts the roadside-device identification information corresponding to the information provision range to which the vehicle 11 belongs, by reference to the roadside-device area information. Next, the movement prediction calculation unit 34 acquires, from the roadside-device delay information, the delay information corresponding to the extracted roadside-device identification information. Then, the movement prediction calculation unit 34 calculates predicted position information using the acquired delay information and probe information.

Next, the roadside-device area management unit 35 designates an information provision range for the roadside server 60 by reference to the request information received in step S13 and the roadside-device area information (step S17). In one example, the roadside-device area management unit 35 acquires, from the roadside-device area information, the information provision range corresponding to information indicating the position of the roadside device 70 or the roadside server 60, such as roadside-device identification information included in the request information received in step S13, and designates it as the information provision range of the roadside server 60.

Thereafter, the provision information generation unit 36 generates surrounding object information by extracting the predicted position information present in the information provision range of the roadside device 70 (step S18). In one example, the provision information generation unit 36 extracts the predicted position information present in the designated information provision range, and assembles the extracted predicted position information to thereby get surrounding object information. In the presence of a plurality of roadside servers 60, the surrounding object information is generated for each roadside server 60.

Then, the provision information generation unit 36 transmits the generated surrounding object information to the roadside server 60 (step S19). At this time, the provision information generation unit 36 transmits the surrounding object information to the roadside server 60 via the base station I/F 31. Through the process described above, the processing in the server 30 ends.

On the other hand, in the roadside server 60, after transmitting the request information in step S12, the sensor I/F 63 receives detection result information from the roadside sensor 50, and the sensor information processing unit 64 generates sensing information using the detection result information from the roadside sensor 50 (step S20). The wide-area communication unit 62 of the roadside server 60 receives the surrounding object information from the server 30 (step S21).

Next, the assistance information generation unit 65 generates driving assistance information by combining the sensing information and the surrounding object information (step S22), and transmits the driving assistance information via the roadside device 70 (step S23). Through the process described above, the processing in the roadside server 60 ends.

The in-vehicle device 10 of the vehicle 15 within the roadside-device communication range of the roadside device 70 connected to the roadside server 60 receives the driving assistance information (step S24), and then displays the driving assistance information with making it superposed on the static map information of the dynamic map (step S25). Consequently, the presence of an object approaching the detection range outside the detection range is displayed on the dynamic map. Through the process described above, the process in the in-vehicle device 10 ends.

In the driving assistance method described above, the process performed by the roadside server 60 corresponds to a driving assistance information generation method. The process performed by the server 30 corresponds to a surrounding object information generation method.

As described above, in the first embodiment, the server 30 uses wide-area communication to collect information such as probe information which is allowed to be delayed during collection and is expected to be collected over a wide range, and processes the information to generate surrounding object information. On the other hand, the roadside server 60 collects information which is not allowed to be delayed such as information from the roadside sensor 50 or the like, generates sensing information from the collected information, and processes the sensing information and the surrounding object information by combining them to generate driving assistance information. Then, the roadside server 60 provides the driving assistance information from the roadside device 70 to the vehicle 15 present in the roadside-device communication range of the roadside device 70. Consequently, the motion of surrounding vehicles outside the detection range of the roadside sensor 50 can also be provided to the vehicle 15 present in the communication area of the roadside device 70, and so more effective information provision can be achieved.

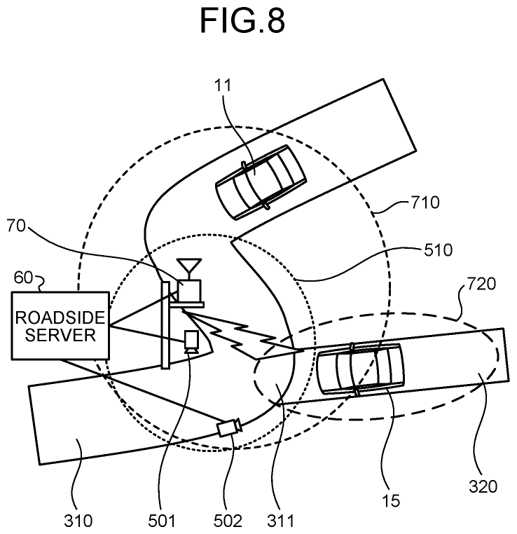

FIG. 8 is a diagram illustrating an example of provision of driving assistance information in the driving assistance system according to the first embodiment. FIG. 8 illustrates an example in which the roadside device 70 and two roadside sensors 501 and 502 are provided near the junction of an S-shaped road 310 and a linear road 320, and the road 320 joins the road 310 near a curve part 311 of the S-shaped road 310. The roadside device 70 has a roadside-device communication range 720 near the junction with the road 320. For example, when the vehicle 15 on the road 320 enters the road 310, the roadside sensors 501 and 502 cannot detect the vehicle 11 present just outside a detection range 510 on the road 310. Therefore, providing the vehicle 15 with only sensing information that is based on the results of detection of the roadside sensors 501 and 502 may result in the vehicle 15 colliding with the vehicle 11 when the vehicle 15 enters the road 310.

However, in the driving assistance system 1 according to the first embodiment, sensing information in the detection range 510 and surrounding object information including information on the vehicle 11 present in an information provision range 710 of the roadside device 70 are combined into driving assistance information which is provided to the vehicle 15 in the roadside-device communication range 720. As a result, the vehicle 15 entering the road 310 can recognize that the vehicle 11 is approaching from the far side of the blind curve. In addition to the vehicle 11, the vehicle 15 can also recognize dynamic objects such as bicycles or persons.

In this manner, in addition to information on vehicles, persons, and the like around the vehicle 15 acquired by the roadside sensors 501 and 502, information on the vehicle 11, persons, and the like approaching from the far side of the curve or the like that cannot be detected by the roadside sensors 501 and 502 can be obtained in wide-area communication, and driving assistance information can be provided to the vehicle 15 over a wider range than the range of assistance information that can be provided using sensing information of the roadside sensors 501 and 502. In addition, the data collected by means of wide-area communication is processed by the server 30 on the wide-area communication side, so that processing in the roadside server 60 can be minimized and processing delay in the roadside server 60 can be reduced.

In the above-described example, the roadside device 70 and the roadside server 60 are configured as their respective separate devices, but they may be configured integrally. In other words, the roadside server 60 may have the function of the roadside device 70.

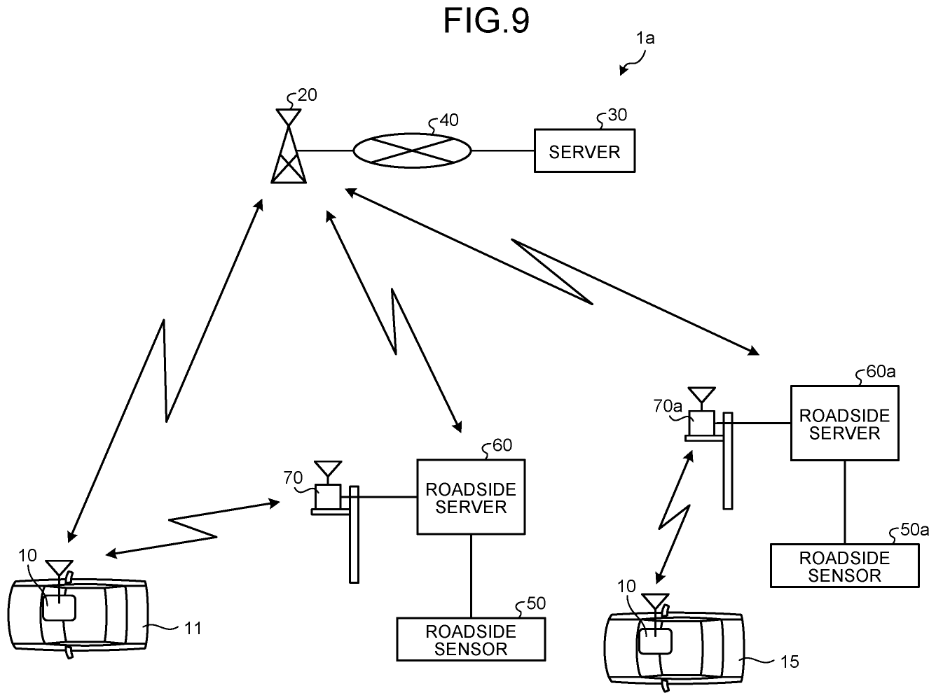

FIG. 1 has been used to describe the driving assistance system 1 in the case where there is one set of the roadside device 70 and the roadside sensor 50, but this case is just an exemplification, and the driving assistance system 1 may have two or more sets of roadside devices 70 and roadside sensors 50. FIG. 9 is a diagram schematically illustrating another exemplary configuration of the driving assistance system according to the first embodiment. Note that components identical to those in FIG. 1 are denoted by the same reference signs, and the description thereof will be omitted. The driving assistance system 1a of FIG. 9 further includes another set of a roadside sensor 50a, a roadside server 60a, and a roadside device 70a.

Here, the roadside device 70a has the same configuration as the roadside device 70, and the roadside server 60a has the same configuration as the roadside server 60. However, the roadside sensor 50a may be the same in type and number as the roadside sensor 50, or may be different in type and number from the roadside sensor 50. In the presence of the plurality of roadside devices 70 and 70a, information on the plurality of roadside devices 70 and 70a is included in the roadside-device area information of FIGS. 3 and 6, and an information provision range is set for each of the roadside devices 70 and 70a. The server 30 provides surrounding object information to each of the roadside servers 60 and 60a based on the roadside-device area information. In addition, information on the plurality of roadside devices 70 and 70a is included in the roadside-device delay information of FIG. 5, and a delay time is set for each of the roadside devices 70 and 70a. In FIG. 9, the plurality of roadside devices 70 and 70a are connected to the same base station 20, but another configuration may be adopted in which the roadside devices 70 and 70a are connected to their respective different base stations 20 connected to the same core network 40.

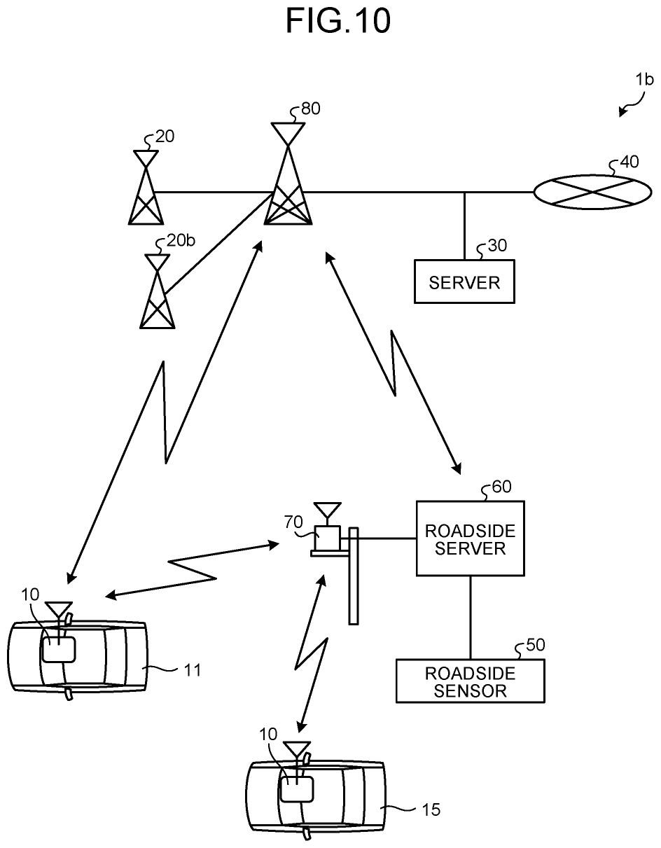

Further, although the server 30 is connected to the core network 40 in the above-described example, the connection position of the server 30 is not necessarily limited to the core network 40. FIG. 10 is a diagram schematically illustrating another exemplary configuration of the driving assistance system according to the first embodiment. Note that components identical to those in the above drawings are denoted by the same reference signs, and the description thereof will be omitted. The driving assistance system 1b illustrated in FIG. 10 further includes an aggregation station 80 connected to the core network 40. A plurality of base stations 20 and 20b are connected to the aggregation station 80. Then, the server 30 is connected between the aggregation station 80 and the core network 40. Note that the base station 20b has a function similar to that of the base station 20.

Also in the following embodiments, description will be given of examples in which the server 30 is connected to the core network 40 as illustrated in FIG. 1, but the connection position of the server 30 is not limited by the examples, because it is conceivable that a plurality of candidates for the connection position of the server 30 for wide-area communication can be set as illustrated in FIG. 10.

### Second Embodiment

The second embodiment describes a case where one roadside server 60 processes information of a plurality of roadside devices 70 and roadside sensors 50.

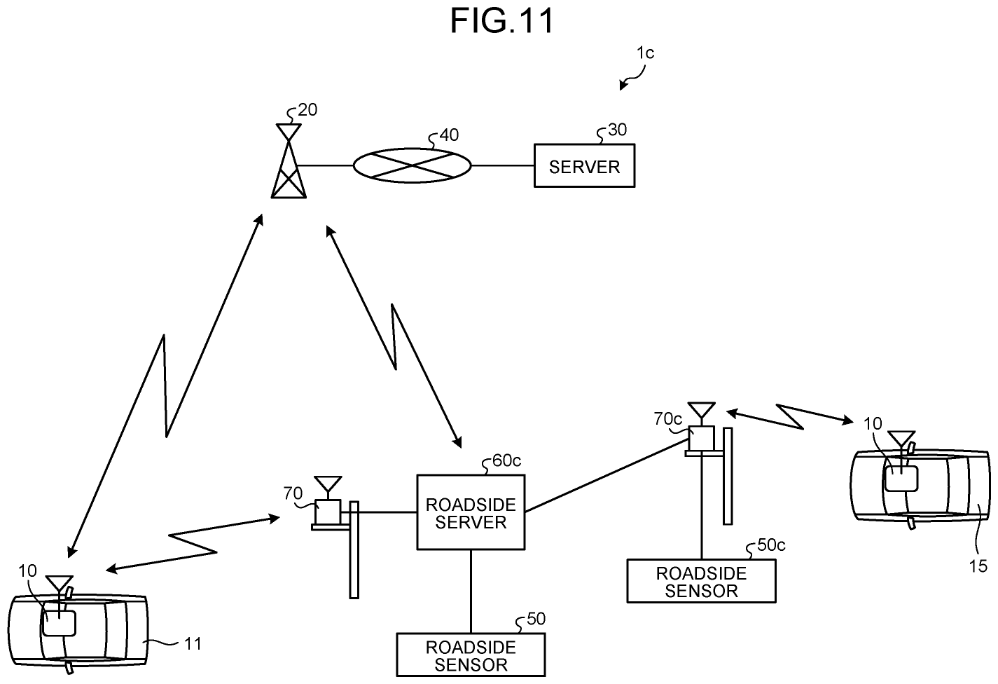

FIG. 11 is a diagram schematically illustrating an exemplary configuration of a driving assistance system according to the second embodiment. Note that components identical to those in the first embodiment are denoted by the same reference signs, the description thereof will be omitted, and differences from the first embodiment will be mainly described. The driving assistance system 1c further includes a roadside device 70c and a roadside sensor 50c connected to the roadside device 70c. The multiple roadside devices 70 and 70c have their respective different roadside-device communication ranges and information provision ranges. The driving assistance system 1c includes a roadside server 60c instead of the roadside server 60 in the first embodiment. The roadside server 60c is connected to the roadside devices 70 and 70c and the roadside sensor 50 via dedicated lines. The roadside sensor 50c is connected to the roadside server 60c via the roadside device 70c. The roadside device 70c corresponds to another roadside device, and the roadside sensor 50c corresponds to another roadside sensor.

The roadside server 60c receives the surrounding object information corresponding to the roadside devices 70 and 70c from the server 30 through wide-area communication. The roadside server 60c generates real-time sensing information about the surroundings of each of the roadside devices 70 and 70c from the detection result information of the roadside sensors 50 and 50c, generates driving assistance information for each of the roadside devices 70 and 70c by combining the sensing information with the surrounding object information of each of the roadside devices 70 and 70c received from the server 30 through wide-area communication, and transmits the driving assistance information to the roadside devices 70 and 70c.

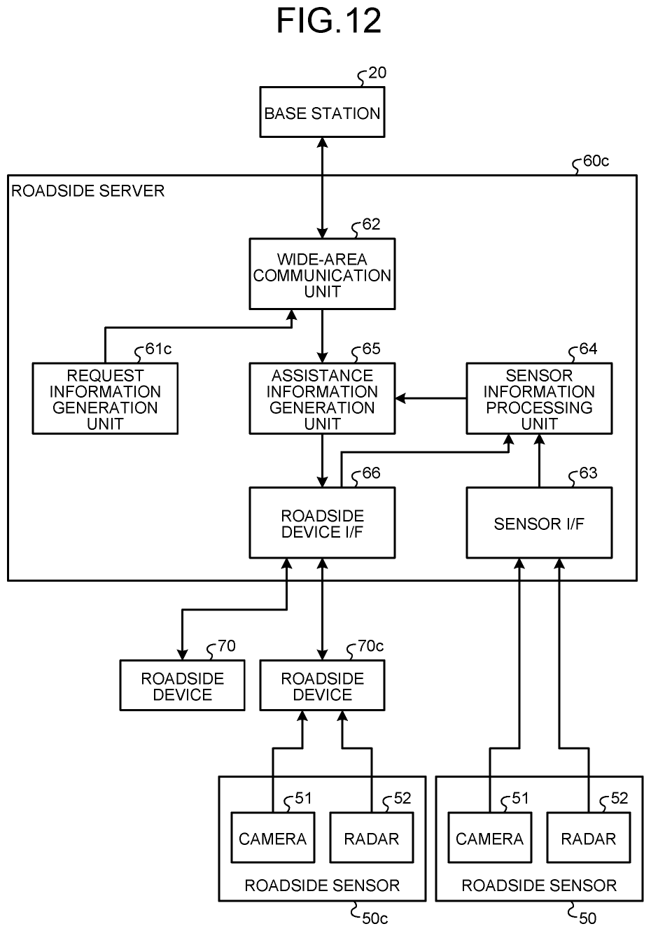

FIG. 12 is a block diagram illustrating an exemplary functional configuration of the roadside server according to the second embodiment. Note that components identical to those in FIG. 2 of the first embodiment are denoted by the same reference signs, the description thereof will be omitted, and differences therefrom will be mainly described. The configuration of the roadside server 60c according to the second embodiment is basically similar to that illustrated in FIG. 2 of the first embodiment. However, as illustrated in FIGS. 11 and 12, because the roadside sensor 50c is connected to the roadside device 70c, the roadside device I/F 66 transmits driving assistance information to the roadside devices 70 and 70c, and also outputs the detection result information of the roadside sensor 50c received from the roadside device 70c to the sensor information processing unit 64.

The request information generation unit 61c generates, for the server 30, request information including information indicating an area of vehicle position information required by the roadside server 60c, that is, information indicating an information provision range. In the second embodiment, in order to generate driving assistance information for the roadside devices 70 and 70c, the roadside server 60c generates, for the server 30, information requesting surrounding object information in the information provision ranges of the roadside devices 70 and 70c.

Here, a generation process in which driving assistance information to be transmitted by the roadside devices 70 and 70c is generated in the roadside server 60c will be described. The detection result information detected by the roadside sensor 50c is inputted to the sensor information processing unit 64 via the roadside device 70c and the roadside device I/F 66. The sensor information processing unit 64 executes a process of generating sensing information in the vicinity of the roadside sensor 50c using the detection result information from the roadside sensor 50c in addition to a process of generating sensing information in the vicinity of the roadside sensor 50 using the detection result information from the roadside sensor 50. Because the roadside sensor 50 and the roadside sensor 50c have their respective different detection ranges, separate processes therefor are conducted in the sensor information processing unit 64, and each piece of sensing information is outputted to the assistance information generation unit 65.

The request information generation unit 61c generates, for the server 30, request information including information indicating the roadside-device position information of the roadside devices 70 and 70c, and the wide-area communication unit 62 transmits the request information to the server 30.

Upon receiving the surrounding object information of the roadside devices 70 and 70c from the server 30 via the wide-area communication unit 62, the assistance information generation unit 65 generates driving assistance information for each of the roadside devices 70 and 70c. Specifically, the assistance information generation unit 65 generates driving assistance information for the roadside device 70 by combining the surrounding object information and the sensing information for the roadside device 70, and generates driving assistance information for the roadside device 70c by combining the surrounding object information and the sensing information for the roadside device 70c. The roadside device I/F 66 transmits the driving assistance information for the roadside device 70 to the roadside device 70, and transmits the driving assistance information for the roadside device 70c to the roadside device 70c.

As described above, in the driving assistance system 1c according to the second embodiment, even when the plurality of roadside devices 70 and 70c are connected to the roadside server 60c, the roadside server 60c generates driving assistance information for each of the roadside devices 70 and 70c by combining the sensing information and the surrounding object information, and transmits the driving assistance information from each of the roadside devices 70 and 70c. Therefore, effects similar to those of the first embodiment can be obtained.

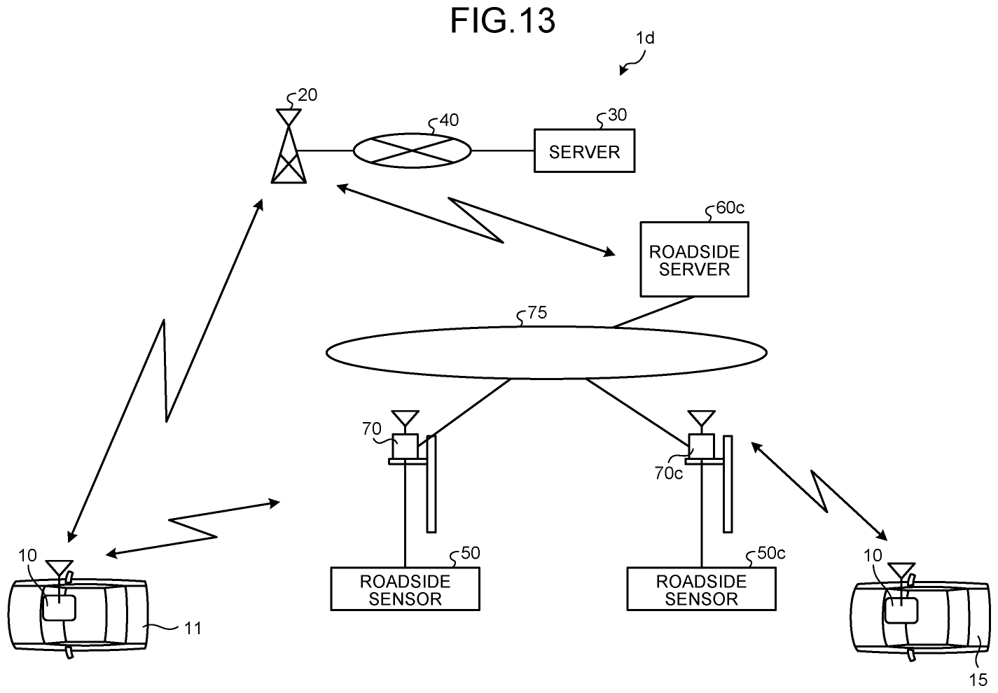

In the above-described example, the roadside device 70 and the roadside server 60c are configured as separate devices, but they may be configured integrally. In the above-described case, the roadside server 60c is disposed in the vicinity of either the roadside device 70 or 70c, but the roadside server 60c may be disposed at a position different from the roadside devices 70 and 70c. FIG. 13 is a diagram schematically illustrating another exemplary configuration of the driving assistance system according to the second embodiment. Note that components identical to those in FIGS. 1 and 11 are denoted by the same reference signs, and the description thereof will be omitted. In the driving assistance system 1d of FIG. 13, the roadside devices 70 and 70c are connected to a network 75. The roadside server 60c is connected to the network 75 of the roadside devices 70 and 70c. In FIG. 13, the roadside sensors 50 and 50c are connected to the roadside devices 70 and 70c, respectively. Each of the roadside sensors 50 and 50c transmits detection result information to the roadside server 60c via the corresponding roadside device 70 or 70c and the network 75.

Further, although there are two sets of the roadside devices 70 and 70c and the roadside sensors 50 and 50c in the above-described example, the number of sets of the roadside devices 70 and 70c and the roadside sensors 50 and 50c may be three or more.

### Third Embodiment

In the first and second embodiments, description has been given of cases in which wide-area communication is provided by one telecommunications carrier that provides mobile phone service. Generally, wide-area communication is provided by two or more telecommunications carriers. In the latter case, the assumption that the server 30 is connected within a network of each telecommunications carrier including the core network 40, an aggregation station, and the like is accompanied by a problem that it is difficult to collect information from vehicles equipped with wide-area communication devices of different telecommunications carriers. In addition, installing the server 30 near the exit from the base station 20 to the Internet results in a considerable increase in delay time, which is also problematic. In the third embodiment, description will be given for a case where wide-area communication is provided by a plurality of telecommunications carriers without increasing delay time.

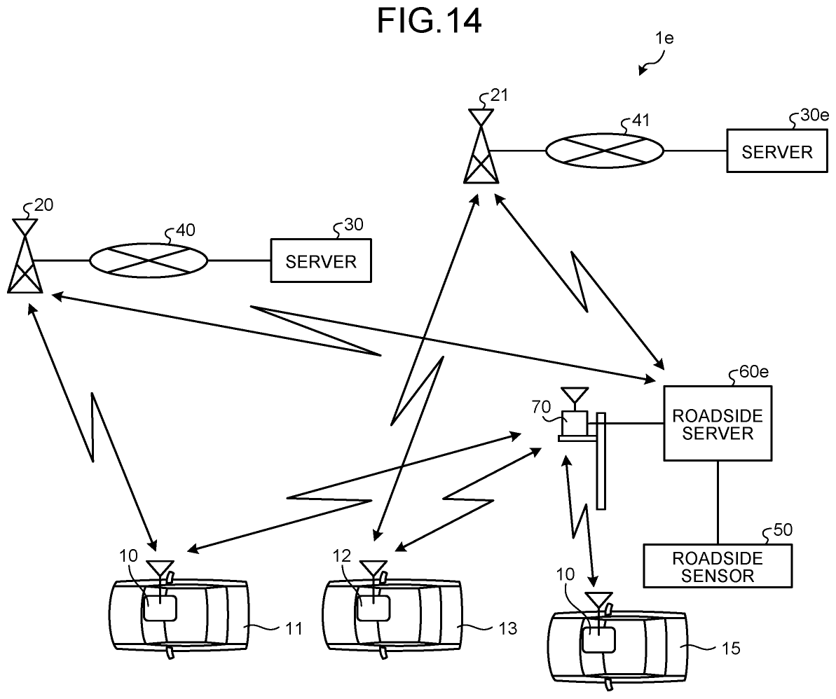

FIG. 14 is a diagram schematically illustrating an exemplary configuration of a driving assistance system according to the third embodiment. Note that components identical to those in the first embodiment are denoted by the same reference signs, the description thereof will be omitted, and differences from the first embodiment will be mainly described. The driving assistance system 1e according to the third embodiment further includes a vehicle 13 equipped with an in-vehicle device 12, a base station 21, and a server 30e. The base station 21 and the server 30e are connected by a core network 41. In FIG. 14, the base station 20 and the core network 40 are provided by a first telecommunications carrier, and the base station 21 and the core network 41 are provided by a second telecommunications carrier different from the first telecommunications carrier. In the third embodiment, in order to distinguish the multiple systems or schemes of wide-area communication from each other, the wide-area communication provided by the first telecommunications carrier is referred to as the first wide-area communication, and the wide-area communication provided by the second telecommunications carrier is referred to as the second wide-area communication. Note that the first telecommunications carrier and the second telecommunications carrier respectively operate a large number of base stations 20 and 21, but one base station 20 and one base station 21 are illustrated in this part for simplicity of description. The server 30e has a configuration similar to that of the server 30. The driving assistance system 1e includes a roadside server 60e instead of the roadside server 60 of the first embodiment.

The in-vehicle device 10 has a wide-area communication interface for the first wide-area communication, and can perform radio communication with the base station 20 by means of the first wide-area communication. The in-vehicle device 10 periodically or regularly transmits the probe information of the vehicle 11 using the first wide-area communication. The probe information transmitted from the in-vehicle device 10 is collected in the server 30 via the base station 20 and the core network 40 for the first wide-area communication. Note that the in-vehicle device 10 cannot perform communication through the second wide-area communication and cannot perform radio communication with the base station 21.

The in-vehicle device 12 has a wide-area communication interface for the second wide-area communication, and can perform radio communication with the base station 21 by means of the second wide-area communication. The in-vehicle device 12 periodically or regularly transmits the probe information of the vehicle 13 using the second wide-area communication. The probe information transmitted from the in-vehicle device 12 is collected in the server 30e via the base station 21 and the core network 41 for the second wide-area communication. Note that the in-vehicle device 12 cannot perform communication through the first wide-area communication and cannot perform radio communication with the base station 20.

The base station 20 performs radio communication with the in-vehicle device 10, the roadside server 60e, and the like by means of the first wide-area communication. The base station 20 cannot perform radio communication with the in-vehicle device 12 capable of communicating through the second wide-area communication. The base station 21 performs radio communication with the in-vehicle device 12, the roadside server 60e, and the like by means of the second wide-area communication. The base station 21 cannot perform radio communication with the in-vehicle device 10 capable of communicating through the first wide-area communication.

The server 30 processes the probe information of the vehicle 11 collected via the base station 20 for the first wide-area communication, and generates surrounding object information to be provided to the roadside server 60e. The server 30e processes the probe information of the vehicle 13 collected via the base station 21 for the second wide-area communication, and generates surrounding object information to be provided to the roadside server 60e.

The roadside server 60e has an interface for wide-area communication that supports the wide-area communications of a plurality of telecommunications carriers. The roadside server 60e receives the surrounding object information from the server 30 through the first wide-area communication, and receives the surrounding object information from the server 30e through the second wide-area communication. In the third embodiment, the surrounding object information received from the server 30 is referred to as the first surrounding object information, and the surrounding object information received from the server 30e is referred to as the second surrounding object information. The roadside server 60e combines the generated sensing information with the first surrounding object information and the second surrounding object information received respectively from the servers 30 and 30e to generate driving assistance information to be provided to the vehicle 15 traveling in the roadside-device communication range of the roadside device 70. The driving assistance information generated by the roadside server 60e is transmitted from the roadside device 70 to the vehicle 15 on the road in the roadside-device communication range.

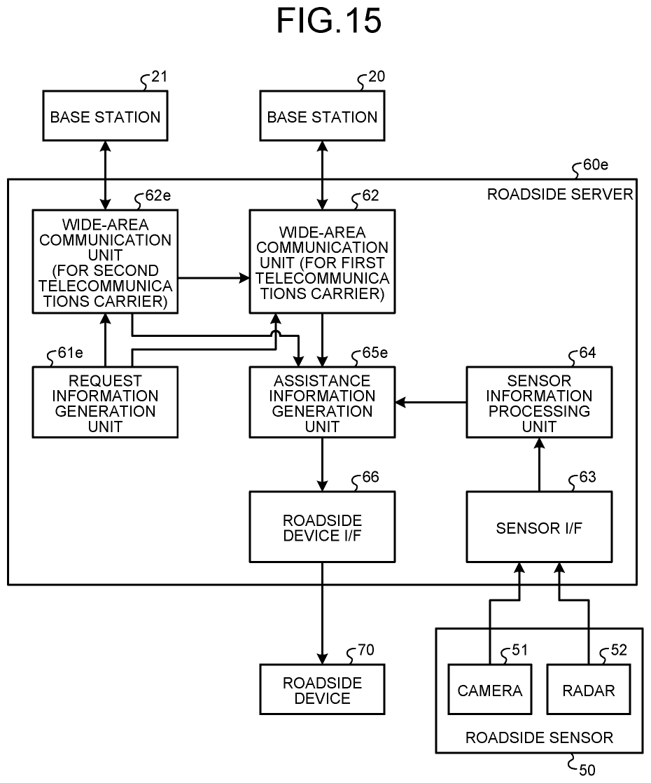

FIG. 15 is a block diagram illustrating an exemplary functional configuration of the roadside server according to the third embodiment. Note that components identical to those in FIG. 2 of the first embodiment are denoted by the same reference signs, the description thereof will be omitted, and differences therefrom will be mainly described. The configuration of the roadside server 60e according to the third embodiment is basically similar to that illustrated in FIG. 2 of the first embodiment. However, as illustrated in FIG. 15, the roadside server 60e includes two wide-area communication units 62 and 62e. That is, the roadside server 60e includes the wide-area communication unit 62 for the first telecommunications carrier which performs radio communication with the base station 20 by means of the first wide-area communication, and the wide-area communication unit 62e for the second telecommunications carrier which performs radio communication with the base station 21 by means of the second wide-area communication. The wide-area communication unit 62 communicates with the server 30 via the base station 20. The wide-area communication unit 62e communicates with the server 30e via the base station 21.

The roadside server 60e includes a request information generation unit or circuit 61e and an assistance information generation unit or circuit 65e instead of the request information generation unit 61 and the assistance information generation unit 65 of the roadside server 60 in the first embodiment.

The request information generation unit 61e generates, for the servers 30 and 30e, request information including information indicating an area of vehicle position information required by the roadside server 60e. In this case, in the servers 30 and 30e and the roadside server 60e, roadside-device area information as illustrated in FIG. 3 is retained.

The assistance information generation unit 65e generates driving assistance information to be transmitted from the roadside device 70 by combining the first surrounding object information of the roadside device 70 acquired from the server 30 via the wide-area communication unit 62, the second surrounding object information of the roadside device 70 acquired from the server 30e via the wide-area communication unit 62e, and the sensing information in the vicinity of the roadside sensor 50 generated by the sensor information processing unit 64.

The server 30e has a function similar to that of the server 30 described in the first embodiment. Because wide-area communication has a longer delay time than narrow-area communication, the movement prediction calculation unit 34 of the server 30e calculates predicted position information in consideration of the delay time taken to complete delivery to the roadside server 60e in the movement prediction calculation unit 34. The servers 30 and 30e have roadside-device delay information, but the delay time in the server 30 and the delay time in the server 30e may be different from each other in calculation of predicted position information for one and the same roadside device 70 due to some delay in communication or processing.

As described above, in the driving assistance system 1e according to the third embodiment, in the case where two or more telecommunications carriers provide wide-area communication, the roadside server 60e receives surrounding object information from the servers 30 and 30e of the respective telecommunications carriers. The roadside server 60e combines the sensing information with the surrounding object information from the respective servers 30 and 30e to generate driving assistance information for the roadside device 70, and transmits the driving assistance information from the roadside device 70. As a result, effects similar to those of the first embodiment can be obtained. That is, information can be collected regardless of the type of wide-area communication, and effective provision of the driving assistance information can be achieved by providing the driving assistance information through narrow-area communication which does not depend on the type of wide-area communication.

In the above-described example, the roadside device 70 and the roadside server 60e are configured as separate devices, but they may be configured integrally. Multiple sets of the roadside device 70 and the roadside server 60e may be provided as in FIG. 9 of the first embodiment, or a plurality of roadside devices 70 may be provided for one roadside server 60e as in FIG. 11 or 13 of the second embodiment.

### Fourth Embodiment

In the fourth embodiment, description will be given for a method for adjusting a time of prediction, that is, a delay time, in obtaining the surrounding object information collected through wide-area communication in the first embodiment.

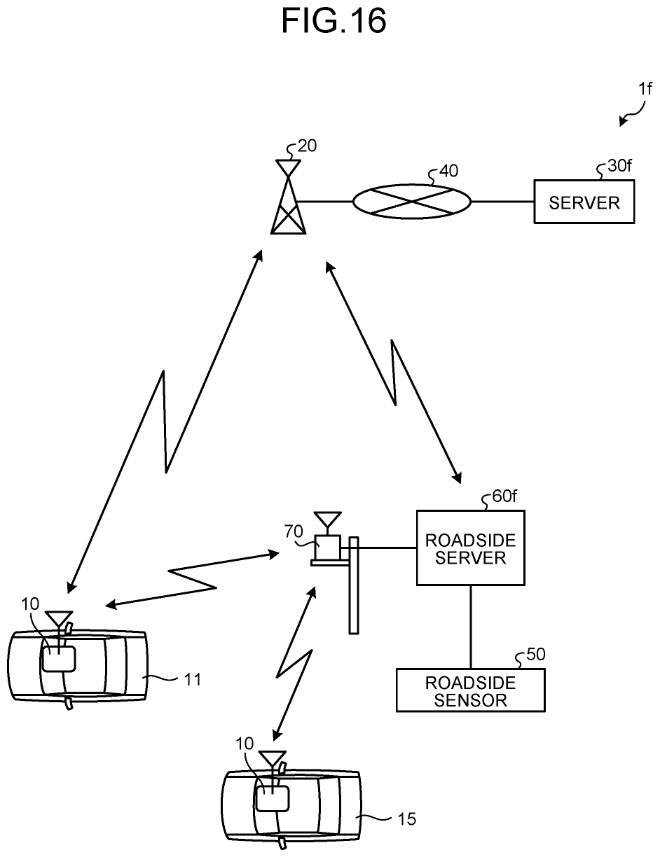

FIG. 16 is a diagram schematically illustrating an exemplary configuration of a driving assistance system according to the fourth embodiment. Note that components identical to those in the first embodiment are denoted by the same reference signs, the description thereof will be omitted, and differences from the first embodiment will be mainly described. The driving assistance system if according to the fourth embodiment includes a server 30f and a roadside server 60f instead of the server 30 and the roadside server 60 in the first embodiment.

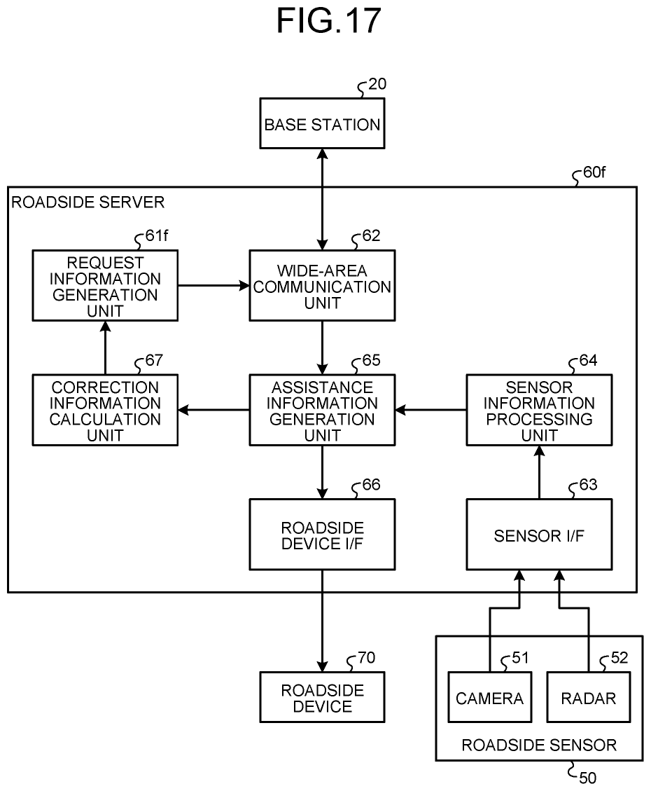

FIG. 17 is a block diagram illustrating an exemplary functional configuration of the roadside server according to the fourth embodiment. Note that components identical to those in FIG. 2 of the first embodiment are denoted by the same reference signs, the description thereof will be omitted, and differences therefrom will be mainly described. The roadside server 60f further includes a correction information calculation unit or circuit 67.

The assistance information generation unit 65 of the roadside server 60f generates driving assistance information by superposing the surrounding object information received by the wide-area communication unit 62 on the sensing information generated by the sensor information processing unit 64. At this time, there may be an error caused between the sensing information obtained from the roadside sensor 50 and the surrounding object information received by the wide-area communication unit 62. For example, there may be a case in which the vehicle 11 in the sensing information and the vehicle 11 in the surrounding object information are identical but are not at the same position. This is because the surrounding object information takes long time to perform communication and processing, and accordingly an error in prediction value is larger than the sensing information. In view of this, in the fourth embodiment, when there is a position gap between the identical vehicles 11 due to some error, the correction information calculation unit 67 calculates the position gap and obtains correction information for the delay time to be used for calculating the predicted position. The correction information for the delay time may be a corrected delay time, an adjustment value for correcting the delay time, or an error to be given as a notification to the server 30f for causing the server 30f to execute correction of the delay time.

The roadside server 60f includes a request information generation unit or circuit 61f instead of the request information generation unit 61 of the roadside server 60 in the first embodiment. The request information generation unit 61f transmits, to the server 60f, request information including information indicating an area of vehicle position information required by the roadside server 60f and the correction information for the delay time obtained by the correction information calculation unit 67.

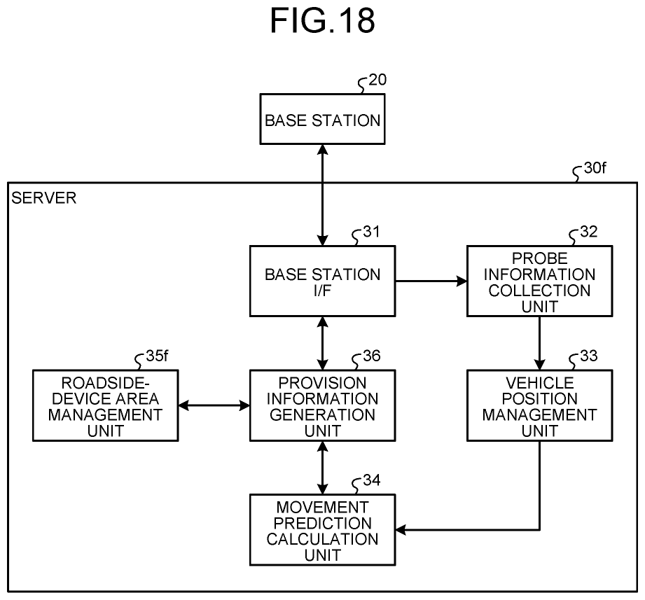

FIG. 18 is a block diagram illustrating an exemplary functional configuration of the server according to the fourth embodiment. Note that components identical to those in FIG. 4 of the first embodiment are denoted by the same reference signs, the description thereof will be omitted, and differences therefrom will be mainly described. The server 30f includes a roadside-device area management unit or circuit 35f instead of the roadside-device area management unit 35 of the server 30 in the first embodiment.

If the request information sent from the roadside server 60f includes correction information for the delay time to be used in the calculation of predicted position information, the roadside-device area management unit 35f updates the delay time using the correction information for the delay time, and passes the updated delay time to the provision information generation unit 36. The delay time to be updated is the delay time associated with the roadside server 60f that is a transmission source of the request information of the roadside-device delay information. In one example, the provision information generation unit 36 passes the updated delay time to the movement prediction calculation unit 34, and the movement prediction calculation unit 34 calculates predicted position information using the updated delay time.

As described above, in the driving assistance system if according to the fourth embodiment, when there is an error caused between the identical vehicles 11 in the sensing information obtained from the roadside sensor 50 and the surrounding object information obtained from the wide-area communication, the roadside server 60f obtains correction information for the delay time to be used for calculating the predicted position, and transmits the correction information for the delay time to the server 30f. The server 30f updates the delay time using the acquired correction information for the delay time, and generates surrounding object information using the updated delay time. Consequently, it is possible to correct the delay time varying with time, thereby bringing about the effect that more accurate driving assistance information can be provided.

In the above-described example, the number of roadside devices 70 is one, but similar processing can be performed with two or more roadside devices 70 or two or more roadside servers 60f. In addition, the correction of the delay time to be used for generating the surrounding object information can be similarly performed even in a case where a plurality of roadside devices 70 is provided for one roadside server 60f as in FIG. 11 or FIG. 13 of the second embodiment, or in a case where the base stations 20 and 21 and the servers 30 and 30f are provided by a plurality of telecommunications carriers as in the third embodiment.

### Fifth Embodiment

In the fifth embodiment, description will be given for a method for making a wireless connection between the roadside device 70 and the roadside server 60 or between the roadside sensor 50 and the roadside server 60.

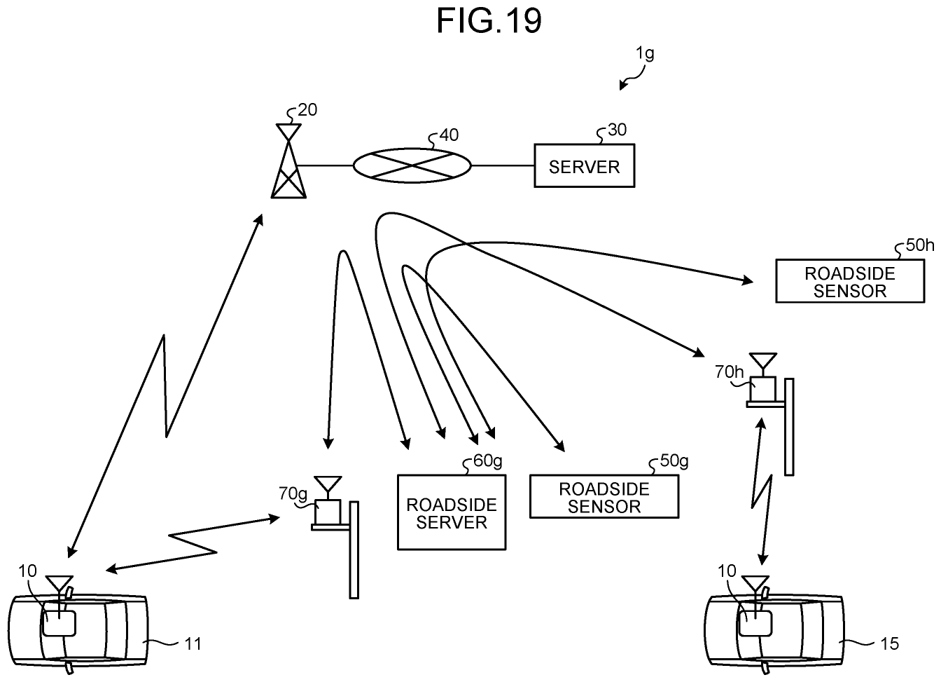

FIG. 19 is a diagram schematically illustrating an exemplary configuration of a driving assistance system according to the fifth embodiment. Note that components identical to those in the first embodiment are denoted by the same reference signs, the description thereof will be omitted, and differences from the first embodiment will be mainly described. The driving assistance system 1g according to the fifth embodiment includes the in-vehicle device 10 provided in the vehicles 11 and 15, the base station 20, the server 30, a roadside sensor 50g, a roadside sensor 50h, a roadside server 60g, a roadside device 70g, and a roadside device 70h. The functions of the in-vehicle device 10, the base station 20, the server 30, the roadside sensors 50g and 50h, the roadside server 60g, and the roadside devices 70g and 70h cover functions similar to those described in the first to fourth embodiments.

In the fifth embodiment, all of the plurality of roadside sensors 50g and 50h, the roadside server 60g, and the plurality of roadside devices 70g and 70h are within the communication range of one and the same base station 20 for wide-area communication, and each have a configuration capable of communicating by radio communication using wide-area communication involving the base station 20. Hereinafter, “within the communication range of one and the same base station 20” is also called “within the same base station 20”.

In this case, the communication within the same base station 20 is based on the premise that a service of transferring packets by return in such a way as to reflect the packets is performed with low delay. Consequently, unlike in the first to fourth embodiments described above, there are no wire connections between the roadside device 70g and the roadside server 60g, between the roadside sensor 50g and the roadside server 60g, between the roadside device 70h and the roadside server 60g, and between the roadside device 70h and the roadside sensor 50h.

The roadside server 60g has an interface for wide-area communication, and receives surrounding object information from the server 30 through wide-area communication. The roadside server 60g is connected to the roadside sensors 50g and 50h and the roadside devices 70g and 70h located within the same base station 20 using the low-delay transfer service within the same base station 20 through wide-area communication. The roadside server 60g generates real-time sensing information about the surroundings of each of the roadside devices 70g and 70h from the detection result information of the roadside sensors 50g and 50h transmitted by means of wide-area communication. Further, the roadside server 60g combines the surrounding object information of the roadside devices 70g and 70h received from the server 30 through wide-area communication with the sensing information of the roadside sensors 50g and 50h to generate driving assistance information to be provided to the vehicle 15 traveling in the roadside-device communication range of each of the roadside devices 70g and 70h. The driving assistance information generated by the roadside server 60g is transmitted from the roadside devices 70g and 70h to the vehicle 15 on the road.

Here, wide-area communication is, for example, radio communication using mobile phone lines in 5G or the like, and narrow-area communication is radio communication for the vehicles 11 and 15 such as DSRC, e.g. communication using a PC5 interface or the like in ETC 2.0, IEEE 802.11p, or 3GPP. In addition, the low-delay transfer service within the same base station 20 used in this case is, for example, the 5G Local Area Network (LAN) service defined by the 3GPP. Note that the low-delay transfer service within the same base station 20 is not limited to the 5G LAN service, and may be any service in which data is transferred with low delay by return within the base station 20.

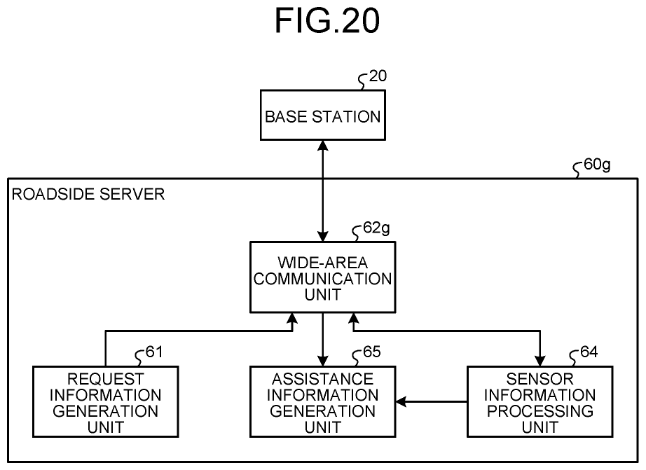

FIG. 20 is a block diagram illustrating an exemplary functional configuration of the roadside server according to the fifth embodiment. Note that components identical to those in FIG. 2 of the first embodiment are denoted by the same reference signs, the description thereof will be omitted, and differences therefrom will be mainly described. The configuration of the roadside server 60g according to the fifth embodiment is obtained by removing the sensor I/F 63 and the roadside device I/F 66 from FIG. 2 of the first embodiment.

The wide-area communication unit 62g and the base station 20 support two types of communication: usual wide-area communication in which a connection is made from the base station 20 to the network behind; and transfer service using wide-area communication in which data is directly transferred by return from the base station 20. In the roadside server 60g, the detection result information of the roadside sensors 50g and 50h received by the wide-area communication unit 62g through the transfer service is inputted to the sensor information processing unit 64. The driving assistance information generated by the assistance information generation unit 65 is passed from the wide-area communication unit 62g to the roadside devices 70g and 70h using the transfer service.

As described above, in the driving assistance system 1g according to the fifth embodiment, the roadside server 60g, the roadside devices 70g and 70h, the roadside sensors 50g and 50h, and the like are wirelessly connected. Consequently, when the roadside server 60g, the roadside devices 70g and 70h, the roadside sensors 50g and 50h, and the like are installed, wiring-related work can be omitted as compared with the case where the roadside server 60g, the roadside devices 70g and 70h, the roadside sensors 50g and 50h, and the like are connected by wire. This brings about the effect that the roadside server 60g, the roadside devices 70g and 70h, the roadside sensors 50g and 50h, and the like can be installed at freely-determined positions without being affected by the wiring environment, in addition to the effects of the first embodiment.

In the example above, description has been given for a form in which the roadside server 60g is wirelessly connected to the roadside devices 70g and 70h and the roadside sensors 50g and 50h by the transfer service of the base station 20, but this is merely an example, and the connections between the roadside server 60g and the roadside devices 70g and 70h and between the roadside server 60g and the roadside sensors 50g and 50h may be partially wireless and the rest may be wired as described in the first to third embodiments. An example of a possible variation is to make a wireless connection only between the roadside server 60g and the roadside device 70h and make the other connections wired.

In the above-described example, there are two sets of the roadside devices 70g and 70h and the roadside sensors 50g and 50h, but the number of sets of the roadside devices 70g and 70h and the roadside sensors 50g and 50h may be one or may be three or more. Further, the roadside sensor 50g or 50h and any one of the plurality of roadside devices 70g and 70h may be integrally configured to communicate with the other roadside device 70g or 70h or with the other roadside sensor 50g or 50h.

### Sixth Embodiment

In the sixth embodiment, description will be given for a case where the in-vehicle device 10 and the roadside server 60 are connected by vehicle-to-vehicle communication that involves a base station (Vehicle to Network to Vehicle: V2N2V).

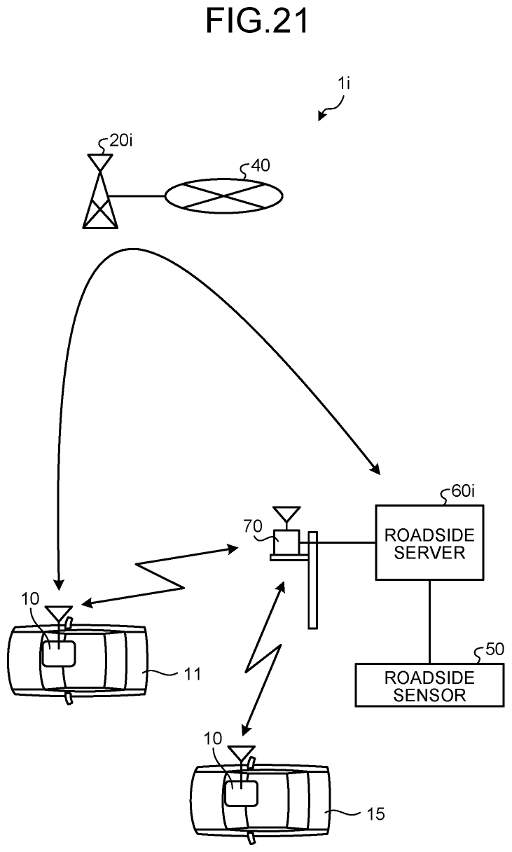

FIG. 21 is a diagram schematically illustrating an exemplary configuration of a driving assistance system according to the sixth embodiment. Note that components identical to those in the first embodiment are denoted by the same reference signs, the description thereof will be omitted, and differences from the first embodiment will be mainly described. The driving assistance system 1i according to the sixth embodiment is based on the premise that communication using wide-area communication can be performed with designation of a roadside server 60i from the in-vehicle device 10 of the vehicle 11. Therefore, the driving assistance system 1i according to the sixth embodiment is different from that of the first embodiment in that the server 30 is not provided. That is, the driving assistance system 1i includes the in-vehicle device 10, the roadside sensor 50, the roadside server 60i, the roadside device 70, and a base station 20i. The base station 20i is connected to the core network 40.

The in-vehicle device 10 has interfaces for both wide-area communication and narrow-area communication. The in-vehicle device 10 periodically or regularly transmits vehicle probe information to the roadside server 60i by V2N2V using wide-area communication, and receives driving assistance information using narrow-area communication.

The base station 20i performs radio communication with the in-vehicle device 10, the roadside server 60i, and the like using wide-area communication, and also supports V2N2V communication.

The roadside server 60i has an interface for wide-area communication, and directly receives probe information from the in-vehicle device 10 of the vehicle 11 by V2N2V. The roadside server 60i is connected to the roadside sensor 50, generates sensing information about the surroundings from the detection result information of the roadside sensor 50, and generates surrounding object information from the probe information collected from the nearby in-vehicle device 10 by V2N2V. The roadside server 60i combines the generated sensing information and surrounding object information to generate driving assistance information to be provided to the vehicle 15 traveling in the roadside-device communication range of the roadside device 70. The driving assistance information generated by the roadside server 60i is transmitted from the roadside device 70 to the vehicle 15 in the roadside-device communication range. Note that the in-vehicle devices 10 of the vehicles 11 and 15 present in the entire area covered by the driving assistance system 1i communicate with the roadside server 60i by means of wide-area communication.

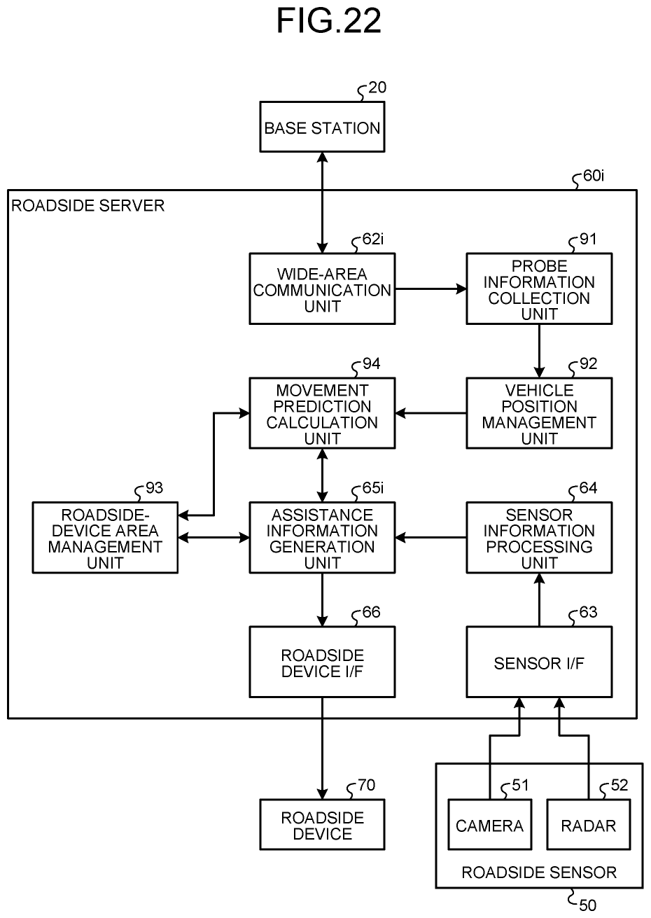

FIG. 22 is a block diagram illustrating an exemplary functional configuration of the roadside server according to the sixth embodiment. Note that components identical to those in FIG. 2 of the first embodiment are denoted by the same reference signs, the description thereof will be omitted, and differences therefrom will be mainly described. The roadside server 60i includes a wide-area communication unit or circuit 62i, the sensor I/F 63, the sensor information processing unit 64, an assistance information generation unit or circuit 65i, the roadside device I/F 66, a probe information collection unit or circuit 91, a vehicle position management unit or circuit 92, a roadside-device area management unit or circuit 93, and a movement prediction calculation unit or circuit 94.

The wide-area communication unit 62i has a function of performing V2N2V communication via the base station 20 by means of wide-area communication.

The probe information collection unit 91 collects, through the wide-area communication unit 62i, the probe information sent by V2N2V from the in-vehicle device 10 of each vehicle 11.

The vehicle position management unit 92 manages, from the collected probe information, vehicle position information including the position and velocity of the vehicle 11 within the information collection range.

The roadside-device area management unit 93 manages roadside-device area information in which the roadside device 70 connected to the roadside server 60i is linked with an information provision range as illustrated in FIG. 3, and roadside-device delay information in which the roadside device 70 is associated with delay information as illustrated in FIG. 5. Note that as illustrated in FIG. 6, the roadside device 70 may be associated with an information provision range and a delay time in the roadside-device area information. In this case, the roadside-device delay information is unnecessary.

The movement prediction calculation unit 94 calculates predicted position information obtained by predicting movement of each vehicle 11, from the position information of each vehicle 11 in consideration of the delay time that is the time required for data collection and processing in the movement prediction calculation unit 94. At this time, the movement prediction calculation unit 94 calculates predicted position information in consideration of the delay time received from the roadside-device area management unit 93.

The assistance information generation unit 65i generates driving assistance information to be delivered from the roadside device 70 by combining the predicted position information present in a predetermined range around the roadside device 70, that is, in the information provision range, obtained by the movement prediction calculation unit 94, with the sensing information in the vicinity of the roadside sensor 50 generated by the sensor information processing unit 64. The information provision range is managed by the roadside-device area management unit 93, and for generating the driving assistance information for the roadside device 70, the vehicle position information included in the information provision range of the roadside device 70 is passed from the movement prediction calculation unit 94 to the assistance information generation unit 65i. The vehicle position information included in the information provision range at this time corresponds to surrounding object information. Then, the assistance information generation unit 65i generates driving assistance information using the surrounding object information regarding the roadside device 70 and the sensing information from the roadside sensor 50 corresponding to the roadside device 70.

Note that although the information handled by the vehicle position management unit 92 and the movement prediction calculation unit 94 has been described as information indicating the position of the vehicle 11, the information can include not only that on the vehicle 11 but also information on pedestrians and the like in the vicinity.

In addition, in the case where the position of the vehicle 11 in the sensing information generated by the sensor information processing unit 64 and the position of the vehicle 11 predicted by the movement prediction calculation unit 94 are estimated to be of one and the same vehicle 11 but are separated by a gap, the delay time can be corrected as in the fourth embodiment.

As described above, in the driving assistance system 1i according to the sixth embodiment, when the in-vehicle device 10 of the vehicle 11 can use V2N2V communication to directly designate a destination and transmit information through wide-area communication to the roadside server 60i, the function of the server 30 on the side of the base station 20 is integrated into the roadside server 60i. With this configuration, effects similar to those of the first embodiment can also be obtained.

Even in the case where two or more systems or schemes of wide-area communications are provided by multiple telecommunications carriers, if the wide-area communications provided by the respective telecommunications carriers support V2N2V, the roadside server 60i can collectively perform processing to implement control that does not depend on the type of telecommunications carrier. Similar configurations can be applied to cases where there are information collection ranges of a plurality of roadside devices 70 and roadside sensors 50.

In addition, information in which traveling positions and transmission destinations are linked with each other can be put in the dynamic map information prepared in advance within the information collection range of the driving assistance system 1i. Consequently, in the presence of a plurality of roadside servers 60i, the roadside server 60i to which V2N2V transmission is directed from each vehicle 11 is determined. In addition, because the position of each vehicle 11 is managed by the vehicle position management unit 92, the roadside server 60i can tell the vehicle 11 leaving the management area of the roadside server 60i the next destination using V2N2V. Further, using narrow-area communication from the roadside device 70 close to the point where the roadside server 60i to communicate is changed, the next destination can be transmitted to the vehicle 11 together with the driving assistance information.

Next, a hardware configuration of the roadside servers 60, 60c, 60e, 60f, 60g, and 60i and the servers 30 and 30f according to the first to sixth embodiments will be described. Hereinafter, the roadside servers 60, 60c, 60e, 60f, 60g, and 60i are referred to as roadside server or servers 60X, and the servers 30 and 30f are referred to as server or servers 30X.

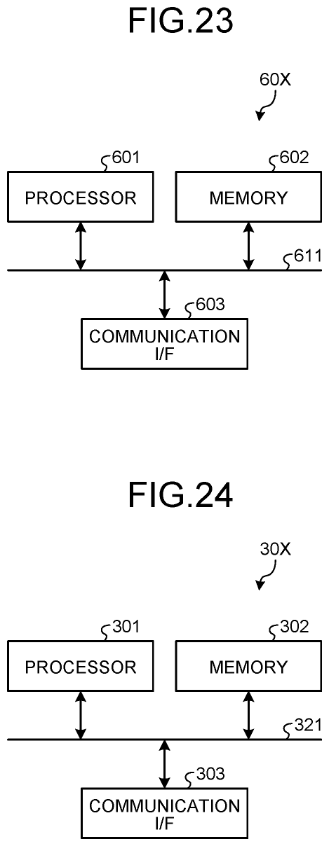

FIG. 23 is a block diagram illustrating an exemplary hardware configuration of the roadside server according to any of the first to sixth embodiments. In one example, the roadside server 60X is implemented by a computer. The roadside server 60X includes a processor 601, a memory 602, and a communication I/F 603. The components of the roadside server 60X are connected to each other via a bus 611.

The processor 601 is composed of a central processing unit (CPU), a field programmable gate array (FPGA), or a combination of CPU and FPGA, and executes various types of processing. The memory 602 stores programs for operating the roadside server 60X, dynamic map information of an area covering driving assistance information that is provided from the roadside server 60X, roadside-device area information, and more.

The processor 601 reads and executes a program stored in the memory 602 via the bus 611, and governs the processing and control of the entire roadside server 60X. The functions of the request information generation units 61, 61c, 61e, and 61f, the sensor information processing unit 64, the assistance information generation units 65, 65e, and 65i, the correction information calculation unit 67, the probe information collection unit 91, the vehicle position management unit 92, the roadside-device area management unit 93, and the movement prediction calculation unit 94 illustrated in FIGS. 2, 12, 15, 17, 20, and 22 are implemented using the processor 601.

The memory 602 is used as a work area of the processor 601. The memory 602 also stores programs including a boot program, a communication program, and a driving assistance information generation program for executing the driving assistance information generation method. For executing the driving assistance information generation method described in the first to sixth embodiments, the processor 601 loads the driving assistance information generation program into the memory 602 and executes various kinds of processing.

The functions of the wide-area communication unit 62, the sensor I/F 63, and the roadside device I/F 66 illustrated in FIG. 2 are implemented using the communication I/F 603. In the case of FIG. 2, the communication I/F 603 is provided for each of the wide-area communication unit 62, the sensor I/F 63, and the roadside device I/F 66.

The communication I/F 603 used to implement the wide-area communication unit 62 performs communication in long term evolution (LTE), 5G, or sixth-generation mobile communication system, for example. Hereinafter, the sixth-generation mobile communication system is referred to as 6th Generation (6G). The communication I/F 603 can connect to the server 30.

The communication I/F 603 used to implement the sensor I/F 63 serves as an interface with the roadside sensor 50, and detection result information from each sensor of the roadside sensor 50 is acquired via the communication I/F 603.

The communication I/F 603 used to implement the roadside device I/F 66 serves as an interface with the roadside device 70, and gives the driving assistance information generated by the processor 601 to the roadside device 70. The communication I/F 603 that implements the roadside device I/F 66 according to the second embodiment can connect to a plurality of roadside devices 70.

The function of the wide-area communication unit 62e illustrated in FIG. 15 is implemented using the communication I/F 603. The communication I/F 603 that implements the wide-area communication unit 62e performs communication in LTE, 5G, or 6G, for example. The communication I/F 603 can connect to the server 30e in FIG. 14.

The function of the wide-area communication unit 62g illustrated in FIG. 20 is implemented using the communication I/F 603. The communication I/F 603 that implements the wide-area communication unit 62g is a communication device capable of performing two types of communication: for example, communication in LTE, 5G, 6G, or the like, and communication in which data is transferred by return by the base station 20 to other communication terminals within the base station 20.

The function of the wide-area communication unit 62i illustrated in FIG. 22 is implemented using the communication I/F 603. The communication I/F 603 that implements the wide-area communication unit 62i is, for example, a communication device that performs communication in LTE, 5G, 6G, or the like, and can also support V2N2V communication. In the case of the roadside server 60i in FIG. 22, the memory 602 stores programs for operating the roadside server 60i, such as processing of probe information, processing of sensor information, and processing of generating driving assistance information, dynamic map information of a cover area of driving assistance information that is provided from the roadside server 60i, roadside-device area information, and the like. The programs for operating the roadside server 60i include a surrounding object information generation program for executing the surrounding object information generation method, and a driving assistance information generation program.

Note that the hardware configuration of the roadside server 60 having the function of the roadside device 70 described in the first embodiment is similar to the configuration of the roadside server 60X illustrated in FIG. 23. In this case, however, the communication I/F 603 that implements the roadside device I/F 66 is not provided, but the communication I/F 603 that implements a narrow-area communication unit or circuit is provided. The communication I/F 603 that implements a narrow-area communication unit or circuit is a communication device for transmitting information to the in-vehicle device 10 of the vehicle 15 present in the roadside-device communication range. In this case, the processor 601 additionally performs control to transmit data to and receive data from the communication I/F 603 that implements a narrow-area communication unit or circuit.

The driving assistance information generation program is a program for causing a computer to function as the roadside server 60X described above. That is, the driving assistance information generation program has the functions of: causing the sensor I/F 63 to acquire the detection result information inputted from the roadside sensor 50; causing the sensor information processing unit 64 to generate sensing information from the detection result information; causing the wide-area communication unit 62 communicating with the base station 20 to acquire the surrounding object information generated by the server 30; causing the assistance information generation unit 65 to generate driving assistance information by combining the sensing information and the surrounding object information; and causing the roadside device I/F 66 to output the driving assistance information to the roadside device 70. In addition, the driving assistance information generation program has the function of outputting information of the roadside device 70 or the like to be transmitted to the server 30 in order to acquire information at the wide-area communication unit 62. Causing a computer to execute this driving assistance information generation program provides the computer with functions similar to those of the roadside server 60X.

The driving assistance information generation program may be stored in a storage medium readable by a computer. The roadside server 60X may be configured to store the driving assistance information generation program stored in the storage medium, in an external storage device that is one form of the memory 602. The storage medium may be a portable storage medium which is a flexible disk or a flash memory which is a semiconductor memory. The driving assistance information generation program may be installed on hardware from another computer or a server device via a communication network.

The functions of the roadside server 60X may be implemented by a processing circuit that is a dedicated hardware set for implementing the driving assistance information generation method. The processing circuit is a single circuit, a composite circuit, a programmed processor, a parallel programmed processor, an application specific integrated circuit (ASIC), an FPGA, or a combination thereof. A part of the processing circuit may be implemented by dedicated hardware, and the other part may be implemented by software or firmware. In this manner, the processing circuit can implement each of the above-described functions by means of dedicated hardware, software, firmware, or a combination thereof.

FIG. 24 is a block diagram illustrating an exemplary hardware configuration of the server according to any of the first to sixth embodiments. In one example, the server 30X is implemented by a computer. The server 30X includes a processor 301, a memory 302, and a communication I/F 303. The components of the server 30X are connected to each other via a bus 321.

The processor 301 is composed of a CPU, an FPGA, or a combination of CPU and FPGA, and executes various types of processing. The memory 302 stores programs for operating the server 30X, dynamic map information of an area covering surrounding object information that is provided from the server 30X, roadside-device area information, roadside-device delay information, and the like.

The processor 301 reads and executes a program stored in the memory 302 via the bus 321, and governs the processing and control of the entire server 30X. The functions of the probe information collection unit 32, the vehicle position management unit 33, the movement prediction calculation unit 34, the roadside-device area management units 35 and 35f, and the provision information generation unit 36, illustrated in FIGS. 4 and 18, are implemented using the processor 301.

The memory 302 is used as a work area of the processor 301. The memory 302 also stores programs including a boot program, a communication program, a surrounding object information generation program for executing the surrounding object information generation method, and the like. For executing the surrounding object information generation method described in the first to sixth embodiments, the processor 301 loads the surrounding object information generation program into the memory 302 and executes various kinds of processing.

Note that in the case of the roadside-device area information illustrated in FIG. 3, the roadside-device area information and the roadside-device delay information illustrated in FIG. 5 are stored in the memory 302, whereas in the case of the roadside-device area information illustrated in FIG. 6, only the roadside-device area information of FIG. 6 is stored in the memory 302, and the roadside-device area information of FIG. 3 and the roadside-device delay information of FIG. 5 are not stored in the memory 302.

The function of the base station I/F 31 illustrated in FIG. 4 is implemented using the communication I/F 303. The communication I/F 303 that implements the base station I/F 31 is an interface for connecting to the base station 20. The data to be processed by the server 30X is inputted from the communication I/F 303, and the processed data is also outputted from the communication I/F 303.

The surrounding object information generation program is a program for causing a computer to function as the server 30X described above. That is, the surrounding object information generation program is configured to collect probe information from the in-vehicle device 10 via the base station 20, and manage the position of each vehicle 11. In addition, the surrounding object information generation program is configured to perform the operations of: acquiring information of the roadside device 70 from the roadside server 60 via the base station 20; calculating predicted position information of the vehicle 11 in the information provision range adapted to the acquired information; and outputting the predicted position information as surrounding object information to the roadside server 60 via the base station 20. By causing a computer to execute this surrounding object information generation program, the computer is supposed to have functions similar to those of the server 30X.

The surrounding object information generation program may be stored in a storage medium readable by a computer. The server 30X may be configured to store the surrounding object information generation program stored in the storage medium, in an external storage device that is a form of the memory 302. The storage medium may be a portable storage medium which is a flexible disk or a flash memory which is a semiconductor memory. The surrounding object information generation program may be installed in hardware from another computer or a server device via a communication network.

The functions of the server 30X may be implemented by a processing circuit that is a dedicated hardware set for implementing the surrounding object information generation method. The processing circuit is a single circuit, a composite circuit, a programmed processor, a parallel programmed processor, an ASIC, an FPGA, or a combination thereof. A part of the processing circuit may be implemented by dedicated hardware, and the other part may be implemented by software or firmware. In this manner, the processing circuit can implement each of the above-described functions by means of dedicated hardware, software, firmware, or a combination thereof.

The driving assistance system according to the present disclosure has an advantageous effect of providing driving assistance information including information on an object approaching the detection range of a roadside sensor from outside the detection range.

The configurations described in the above-mentioned embodiments illustrate just examples, each of which can be combined with other publicly known techniques. The embodiments can be combined with each other, and part of the configuration can be omitted and/or modified without departing from the scope of the present disclosure.

What is claimed is:

1. A driving assistance system comprising a roadside server connected to a roadside sensor and a roadside device, the roadside server acquiring information from the roadside sensor and transmitting driving assistance information to the roadside device, wherein
the roadside server comprises:
a sensor information processing circuit to generate sensing information using information indicating a state in a detection range of the roadside sensor from the roadside sensor, the sensing information including a position and a movement direction of a first dynamic object within the detection range;
an assistance information generation circuit to generate driving assistance information by combining surrounding object information and the sensing information, the surrounding object information being obtained by extracting predicted position information present within an information provision range including the detection range and being wider than the detection range, the predicted position information including a predicted position of a second dynamic object predicted from probe information in consideration of delays in wide-area communication that uses radio communication involving a base station and in processing in the roadside server, the probe information including a position and a velocity of the second dynamic object within a predetermined range and being allowed to be delayed, the driving assistance information including a position and a velocity of a dynamic object in the information provision range; and
a roadside device interface to transmit the driving assistance information to the roadside device.

2. The driving assistance system according to claim 1, further comprising a server communicably connected to the roadside server through the wide-area communication, wherein
the server comprises:
a movement prediction calculation circuit to calculate the predicted position information of the second dynamic object using the probe information of the second dynamic object and a delay time obtained in consideration of the wide-area communication and processing in the roadside server;
a provision information generation circuit to generate the surrounding object information obtained by extracting the predicted position information of the second dynamic object present within the information provision range; and
a base station interface to transmit the surrounding object information to the roadside server via the base station.

3. The driving assistance system according to claim 2, wherein
the roadside server further comprises a wide-area communication circuit to communicate with the server in the wide-area communication, and
the wide-area communication circuit receives the surrounding object information from the server.

4. The driving assistance system according to claim 3, wherein
the roadside server further comprises a request information generation circuit to generate request information including designation of the information provision range in which the surrounding object information is acquired for the roadside device,
the wide-area communication circuit of the roadside server transmits the request information to the server,
the server further comprises a roadside-device area management circuit to refer to roadside-device area information that is information in which the roadside device and the information provision range are linked with each other, and pass the information provision range designated by the request information to the provision information generation circuit, and
the provision information generation circuit of the server extracts the predicted position information of the second dynamic object present within the information provision range passed from the roadside-device area management circuit, and generates the surrounding object information.

5. The driving assistance system according to claim 4, wherein
the roadside server further comprises a correction information calculation circuit to calculate correction information for correcting the delay time when there is a gap between the surrounding object information and the sensing information,
the wide-area communication circuit of the roadside server transmits the correction information to the server, and
the roadside-device area management circuit of the server updates the delay time using the correction information.

6. The driving assistance system according to claim 3, wherein
when there are multiple types of the wide-area communication,
the server is provided for each type of the wide-area communication, and
the roadside server includes the wide-area communication circuit for each type of the wide-area communication.

7. The driving assistance system according to claim 1, wherein
the roadside server is further connected to an other roadside device to which an other roadside sensor is connected, and
the roadside server generates and transmits the driving assistance information for each of the roadside device and the other roadside device.

8. The driving assistance system according to claim 1, wherein the roadside device interface communicates with the roadside device via the base station in the wide-area communication.

9. The driving assistance system according to claim 1, wherein
when a communication device of the second dynamic object is capable of performing communication using the wide-area communication by designating the roadside server,
the roadside server further comprises a movement prediction calculation circuit to calculate the predicted position information of the second dynamic object using the probe information of the second dynamic object and a delay time obtained in consideration of the wide-area communication and processing in the roadside server, and
the assistance information generation circuit uses the surrounding object information obtained by extracting the predicted position information of the second dynamic object present within the information provision range.

10. The driving assistance system according to claim 1, wherein the first dynamic object and the second dynamic object include any of a vehicle, a person, and a bicycle.

11. A server device connected to a roadside sensor and a roadside device, which acquires information from the roadside sensor and transmits driving assistance information to the roadside device, the server device comprising:
a sensor information processing circuit to generate sensing information using information indicating a state in a detection range of the roadside sensor from the roadside sensor, the sensing information including a position and a movement direction of a first dynamic object within the detection range;
an assistance information generation circuit to generate driving assistance information by combining surrounding object information and the sensing information, the surrounding object information being obtained by extracting predicted position information present within an information provision range including the detection range and being wider than the detection range, the predicted position information including a predicted position of a second dynamic object predicted from probe information in consideration of delays in wide-area communication that uses radio communication involving a base station and in processing in the server device, the probe information including a position and a velocity of the second dynamic object within a predetermined range and being allowed to be delayed, the driving assistance information including a position and a velocity of a dynamic object in the information provision range; and
a roadside device interface to transmit the driving assistance information to the roadside device.

12. A driving assistance information generation method for a roadside server connected to a roadside sensor and a roadside device, the roadside server acquiring information from the roadside sensor and transmitting driving assistance information to the roadside device, the driving assistance information generation method comprising:
a step of generating, by the roadside server, sensing information using information indicating a state in a detection range of the roadside sensor from the roadside sensor, the sensing information including a position and a movement direction of a first dynamic object within the detection range;
a step of generating, by the roadside server, driving assistance information by combining surrounding object information and the sensing information, the surrounding object information being obtained by extracting predicted position information present within an information provision range including the detection range and being wider than the detection range, the predicted position information including a predicted position of a second dynamic object predicted from probe information in consideration of delays in wide-area communication that uses radio communication involving a base station and in processing in the roadside server, the probe information including a position and a velocity of the second dynamic object within a predetermined range and being allowed to be delayed, the driving assistance information including a position and a velocity of a dynamic object in the information provision range; and
a step of transmitting, by the roadside server, the driving assistance information to the roadside device.
